(19) United States
(12) Patent Application Publication
(10) Pub. No.: US 2021/0374696 A1
(43) Pub. Date: Dec. 2, 2021

(54) Public-Private Pegged Blockchains for Regulatory-Zone Restricted Whitebox Programmable Cellular Devices

(71) Applicants: AT&T Global Network Services Hong Kong LTD, Island East (HK); AT&T Mobility II LLC, Atlanta, GA (US)

(72) Inventors: Winnie Chau, Hong Kong (HK); Shashi Gowda, Lantau Island (HK); John Philip Mulligan, Island South (HK)

(73) Assignees: AT&T Global Network Services Hong Kong LTD, Island East (HK); AT&T Mobility II LLC, Atlanta, GA (US)

(21) Appl. No.: 16/888,804

(22) Filed: May 31, 2020

(51) Int. Cl. G06Q 20/08; G06Q 20/02; G06Q 20/06; G06Q 20/40; G06Q 30/00; G06Q 20/30; G06Q 10/10; G06F 16/23; G06F 16/27; H04L 29/06; G06F 21/60; H04L 12/66; H04L 12/911

(52) U.S. Cl. CPC G06Q 20/085; G06Q 2220/00; G06Q 20/065; G06Q 20/405; G06Q 30/0185; G06Q 20/401; G06Q 20/308; G06Q 10/10; G06F 16/2379; G06F 16/27; H04L 63/02; G06F 21/602; H04L 12/66; H04L 47/827; G06Q 20/027

(57) ABSTRACT

A gateway can provision a device serial number. The gateway can generate a private blockchain identifier and a public blockchain identifier for a device. The gateway can create a private mapping between the device serial number and the private blockchain identifier. The gateway can create a public mapping between the device serial number and the public blockchain identifier. The gateway can allocate a private digital currency amount to the private blockchain identifier and a public digital currency amount to the public blockchain identifier. The gateway can provision a private service transaction cost to the public blockchain identifier, a public service transaction cost to the public blockchain identifier, a private service transaction fee to the private blockchain identifier, a public service transaction fee to the public blockchain identifier, and a ruleset for the device. The gateway can register the public blockchain identifier and the private blockchain identifier with a network gateway.

### BACKGROUND

Many industries across a wide range of business verticals are struggling with emerging technology. The logistics industry, for example, is made up of fragmented supply chain partners that have no cohesive industry-wide communications standard to tie them together. Some logistics firms are developing, or have already deployed, Internet of Things (“IoT”) solutions to help address enterprise efficiencies. These silo solutions, while providing greater operational visibility, fail to provide a mechanism for collaborative and integrated solutions that securely allow for information exchange across the supply chain. The primary challenge for transparent IoT data exchange between enterprises is the lack of a common framework for verification, trust, and auditability.

### SUMMARY

Concepts and technologies disclosed herein are directed to aspects of public-private pegged blockchains for regulatory-zone restricted whitebox programmable cellular devices. According to one aspect of the concepts and technologies disclosed herein, a gateway can provision a device serial number for a device. The gateway can generate a device private blockchain identifier and a device public blockchain identifier of the device. The gateway can create a device private mapping between the device serial number and the device private blockchain identifier. The gateway also can create a device public mapping between the device serial number and the device public blockchain identifier. The gateway can allocate a device private digital currency amount to the device private blockchain identifier and a device public digital currency amount to the device public blockchain identifier. The gateway can provision a device private service transaction cost per transaction-type to the device public blockchain identifier. The gateway also can provision a device public service transaction cost per transaction-type to the device public blockchain identifier. The gateway can provision a device private service transaction fee, or fees, per transaction-type to the device private blockchain identifier. The gateway also can provision a device public service transaction fee, or fees, per transaction-type to the device public blockchain identifier. The gateway can provision a device ruleset of the device. The gateway can register the device public blockchain identifier and the device private blockchain identifier with a network gateway.

In some embodiments, the gateway can generate the device private blockchain identifier on a private device database. The gateway also can generate the public blockchain identifier on a public device database. The private device database can be or can include a private blockchain. The private blockchain can be made available to an exclusive set of entities such as third parties, enterprises, and/or other entities. The public device database can be or can include a public blockchain. The public blockchain can be made available to a non-exclusive set of entities such as third parties, enterprises, and/or other entities.

In some embodiments, the gateway is a home gateway associated with a home data governance zone (“DGZ”). The home data governance zone can be one of a plurality of data governance zones in which the device is allowed to operate. In some other embodiments, the gateway is a visited gateway associated with a visited data governance zone. The visited DGZ can be one of the plurality of data governance zones in which the device is allowed to operate.

In some embodiments, the gateway can provision an asset serial number for an asset. The gateway can generate an asset private blockchain identifier and an asset public blockchain identifier for the asset. The gateway can create an asset private mapping between the asset serial number and the asset private blockchain identifier. The gateway also can create an asset public mapping between the asset serial number and the asset public blockchain identifier. The gateway can allocate an asset private digital currency amount to the asset private blockchain identifier and an asset public digital currency amount to the asset public blockchain identifier. The gateway can provision an asset private service transaction cost per transaction-type to the asset private blockchain identifier. The gateway also can provision an asset public service transaction cost per transaction-type to the asset public blockchain identifier. The gateway can provision an asset private service transaction fee, or fees, per transaction-type to the asset private blockchain identifier. The gateway also can provision an asset public service transaction fee, or fees, per transaction-type to the asset public blockchain identifier. The gateway can provision an asset ruleset for the asset. The gateway can register the asset public blockchain identifier and the asset private blockchain identifier with the network gateway.

According to another aspect of the concepts and technologies disclosed herein, a gateway can receive a message from a device. The gateway can parse, from the message, a device serial number, a message type, and a payload. The gateway can determine whether the device serial number is valid. In response to determining that the device serial number is valid, the gateway can retrieve a device public blockchain identifier and a device private blockchain identifier. The gateway can create a public blockchain transaction payload. The gateway can send the public blockchain transaction payload to a public blockchain transaction pool associated with a public blockchain. The gateway can obtain, from the public blockchain, a public blockchain transaction result. In response to the public blockchain transaction result indicating that the public blockchain transaction payload was successfully added to the public blockchain transaction pool, the gateway can obtain a public blockchain transaction ID. The gateway can create a private blockchain transaction payload that includes the public blockchain transaction ID. The gateway can send the private blockchain transaction payload to a private blockchain transaction pool associated with a private blockchain. The gateway can obtain, from the private blockchain, a private blockchain transaction result. The private blockchain transaction result can indicate whether the private blockchain transaction payload was successfully added to the private blockchain transaction pool. In some embodiments, the gateway can verify the public blockchain transaction payload and the private blockchain transaction payload.

In some embodiments, the gateway can determine if the message is associated the device only or the device and an asset. If the message is associated with the device and the asset, the gateway can parse an asset serial number from the message, and further in response to determining that the device serial number is valid, the gateway can determine whether the asset serial number is valid. In response to determining that the asset serial number is valid, the gateway can retrieve an asset public blockchain identifier and an asset private blockchain identifier. The gateway can create a public blockchain transaction payload. The gateway can send the public blockchain transaction payload to a public blockchain transaction pool. The gateway can obtain, from the public blockchain, a public blockchain transaction result. In response to the public blockchain transaction result indicating that the public blockchain transaction payload was successfully added to the public blockchain transaction pool, the gateway can obtain a public blockchain transaction ID. The gateway can create a private blockchain transaction payload that includes the public blockchain transaction ID. The gateway can send the private blockchain transaction payload to the private blockchain transaction pool. The gateway can obtain, from the private blockchain, a private blockchain transaction result. The private blockchain transaction result can indicate whether the private blockchain transaction payload was successfully added to the private blockchain transaction pool. In some embodiments, the gateway can verify the public blockchain transaction payload and the private blockchain transaction payload.

In some embodiments, in response to determining that the message is associated with the device only, the gateway can add a ruleset that includes a device ruleset to the public blockchain transaction payload. In response to determining that the message is associated with the device and the asset, the gateway can add the device private blockchain identifier and the ruleset that includes an asset ruleset to the public blockchain transaction payload.

In some embodiments, the gateway can add, to the public blockchain transaction payload, a public message field of a plurality of message fields of the payload of the message. The gateway can add, to the public blockchain transaction payload, the message type. The gateway can add, to the public blockchain transaction payload, a transaction cost for the message type. The gateway can add, to the public blockchain transaction payload, a transaction fee for the message type.

In some embodiments, in response to determining that the message is associated with the device only, the gateway can add a ruleset that includes a device ruleset to the private blockchain transaction payload. In response to determining that the message is associated with the device and the asset, the gateway can add the device private blockchain identifier and the ruleset that includes an asset ruleset to the private blockchain transaction payload.

In some embodiments, the gateway can add, to the private blockchain transaction payload, a private message field of a plurality of message fields of the payload of the message. The gateway can add, to the private blockchain transaction payload, the message type. The gateway can add, to the private blockchain transaction payload, a transaction cost for the message type. The gateway can add, to the private blockchain transaction payload, a transaction fee for the message type.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIGS. 1A-1D are block diagrams illustrating aspects of an illustrative operating environment in which the concepts and technologies disclosed herein can be implemented.

FIG. 2 is a flow diagram illustrating aspects of a method for provisioning a new enterprise edge gateway (e.g., device gateway or third party gateway), according to an illustrative embodiment.

FIG. 3A is a flow diagram illustrating aspects of a method for network provisioning of a new device for operation, according to an illustrative embodiment.

FIG. 3B is a flow diagram illustrating aspects of a method for just-in-time network provisioning of a new device for operation, according to an illustrative embodiment.

FIG. 3C is a flow diagram illustrating aspects of a method for dynamic just-in-time network provisioning of a new device for operation in a visited data governance zone, according to an illustrative embodiment.

FIG. 4A is a flow diagram illustrating aspects of a method for network provisioning of a new asset for operation, per service type, according to an illustrative embodiment.

FIG. 4B is a flow diagram illustrating aspects of a method for dynamic just-in-time network provisioning of a new asset for operation, per service type, according to an illustrative embodiment.

FIG. 4C is a flow diagram illustrating aspects of a method for dynamic just-in-time network provisioning of a new device+asset for operation, per service type, in a visited data governance zone, according to an illustrative embodiment.

FIG. 5A is a block diagram illustrating aspects of a device-only blockchain transaction payload, according to an illustrative embodiment.

FIG. 5B is a block diagram illustrating aspects of a device+asset blockchain transaction payload, according to an illustrative embodiment.

FIG. 6 is a flow diagram illustrating aspects of a method for handling a data flow for a device-only message, according to an illustrative embodiment.

FIG. 7 is a flow diagram illustrating aspects of a method for handling a data flow for a device+asset message, according to an illustrative embodiment.

FIG. 8 is a flow diagram illustrating aspects of a method for creating a public blockchain transaction and obtaining a public blockchain transaction result, according to an illustrative embodiment.

FIG. 9 is a flow diagram illustrating aspects of a method for creating a private blockchain transaction and obtaining a private blockchain transaction result, according to an illustrative embodiment.

FIG. 10 is a flow diagram illustrating aspects of a method for verifying public versus private IoT transaction integrity of individual devices or assets serial by a home enterprise edge gateway, according to an illustrative embodiment.

FIG. 11 is a flow diagram illustrating aspects of a method for verifying public individual device or asset IoT transaction integrity by a participating enterprise edge gateway, according to an illustrative embodiment.

FIG. 12 is a flow diagram illustrating aspects of a method for ruleset verification of public device or asset data by any participating enterprise edge gateway, according to an illustrative embodiment.

FIG. 13 is a block diagram illustrating aspects of an exemplary data source device implemented as a combination device (also referred to herein as “device+asset”) that includes an asset and an IoT device, according to an illustrative embodiment.

FIG. 14 is a block diagram illustrating an example computer system that can be used to implement aspects of the concepts and technologies disclosed herein, according to an illustrative embodiment.

FIG. 15 is a block diagram illustrating a network that can be used to implement aspects of the concepts and technologies disclosed herein, according to an illustrative embodiment.

FIG. 16 is a block diagram illustrating an example cloud computing platform that can be used to implement aspects of the concepts and technologies disclosed herein, according to an illustrative embodiment.

FIG. 17 is a block diagram illustrating an example mobile device and components thereof, according to an illustrative embodiment.

### DETAILED DESCRIPTION

The concepts and technologies disclosed herein provide a private-public pegged blockchain solution to allow IoT participants with compliant, certified devices to securely exchange information between enterprises and allow for the sharing of data insights. This solution not only addresses the challenge of enterprise-to-enterprise communication by creating a trust and verification framework, but also helps in solving the governance and regulatory challenges for IoT assets as they cross borders. The concepts and technologies disclosed herein can utilize data governance zones (“DGZs”), which are geographically bounded regions of common regulatory conformance, that efficiently and dynamically route IoT traffic in compliance with the regulatory restrictions of the region from which the device transmits data at any particular point in time.

A novel feature of the private-public pegged blockchain solution is a smart contract that is established between public and private blockchain transactions. The smart contract assures ecosystem participants that every public, anonymous transaction within the blockchain network has at least one corresponding private transaction, which cannot be modified or tampered with by any enterprise, including the private enterprise that owns the private blockchain. This feature allows for ecosystem transparency, auditability and forensic traceability, ensuring trust across all participating enterprises within the blockchain network. A result of the innovations disclosed herein is allowing enterprises to develop fully functional, predictive, and operational IoT applications for regulatory-conformant foreign IoT devices, despite having no custodial ownership over them.

Beyond this public-private verification, the private-public pegged blockchain solution provides an additional three-tier layered proof mechanism to ensure both the integrity of IoT message enumeration, as well as a rules-based contract for enterprises to programmatically validate the IoT data of foreign devices. The first two tiers establish a distributed simplified payment verification that participating blockchain nodes can use to track the enumerated count and the specific chronological order of all IoT data produced by all devices within the bounds of a given DGZ. The final proof tier uses rulesets, included within each IoT data transaction, as a smart control mechanism to allow any participating node to programmatically perform three primary and critical functions for the operation of IoT applications. First, the blockchain node is able to validate the integrity and conformance of IoT data included in the blockchain transaction by algorithmically certifying that each IoT device parameter is within the bounds of the defined ruleset. Second, the blockchain node can verify the authenticity of any out-of-bound exceptions (e.g., high temperature exceeds defined ruleset bounds of a refrigerated container) flagged by foreign devices. The blockchain node can recognize, via the smart contract, when a foreign device has violated a ruleset by not raising an out of bounds exception when it should have. Third, the blockchain node can use the ruleset to predict and set the appropriate timers and flags for when the next IoT message should arrive from a foreign IoT device. This final proof tier provided by the disclosed blockchain solution allows enterprises to develop fully functional, predictive, and operational IoT applications for regulatory-conformant foreign IoT devices, despite having no custodial ownership over them.

The disclosed blockchain solution allows devices and assets to be provisioned separately, each with its own unique blockchain identifier (referred to herein as an “eAsset-ID”). This eAsset-ID is created for both the public blockchain and the private blockchain. These eAsset-IDs are created with replenishable digital currency amounts. When a device or a device+asset generates IoT data, the transmission of that data costs some amount of digital currency. By spending this digital currency, the blockchain ledger infrastructure incorporates the IoT data into the ledger along with the amount spent. This IoT data then becomes permanently stored within the distributed ledger.

The concepts and technologies disclosed herein allow for provisioned parameters for data governance, service and transaction fees, and provide customers with greater flexibility in IoT service creation. The concepts and technologies disclosed herein also allow customers to choose which IoT parameters to be published via the public blockchain, while remaining parameters are published only to the private sidechain.

When an IoT message is received, a series of security checks allow verification and authentication of the device/asset combination and establish a proof-of-source before IoT data can be committed to the public and private blockchains. The IoT message fields can then be analyzed to determine which fields can be published via the public blockchain, and a public transaction is set into the blockchain for commitment. Once the public transaction has been committed to the blockchain, a separate private transaction is also committed, and a 1-way smart contract is established between the two transactions and committed to the network. In this manner, the transactions and the smart contract become inseparable. The smart contract ensures both anonymity for the private enterprise that owns the IoT data, while at the same time assuring all public enterprises that consume the public IoT data that there is at least one private enterprise that owns the private IoT data.

The concepts and technologies disclosed herein also utilize a number of checks to ensure the integrity of individual IoT devices and assets. Some checks run continuously on a per-transaction basis, while others can be tuned to run continuously or randomly, depending on the use case and the customer's preferences.

As countries globally implement cyber security laws, privacy guidelines, and encryption restrictions, it can be a tremendous burden for IoT device and platform providers to confidently deploy solutions for assets that cross national borders. By providing a secure protocol and regulator-aware middleware platform, telecommunications service providers, such as AT&T, are uniquely positioned to help both solutions providers and enterprises that require these solutions to be deployed with confidence. The concepts and technologies disclosed herein can allow telecommunications service providers, such as AT&T, to function as an “Ecosystem Facilitator,” enabling unique IoT and emerging technology use cases with rapid transitions from proof of concept to operational support across a wide range of industries. The disclosed concepts and technologies address a void created by existing IoT solution providers and provide a solution that the market needs to accelerate innovation with an almost negligible risk to return on investment. The disclosed concepts and technologies will allow telecommunications service providers, such as AT&T, to foster and grow an ecosystem of device and systems integration partners across almost every emerging technology industry. For large, existing enterprise customers, this ecosystem will put telecommunications service providers, such as AT&T, in the position of picking the best-of-breed partners from across the ecosystem to solve critical customer needs rapidly and with a level of solution quality that competitive solutions will not be able to match.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of systems, devices, computer-readable storage mediums, and methods for public-private pegged blockchains for regulatory-zone restricted whitebox programmable cellular devices will be described.

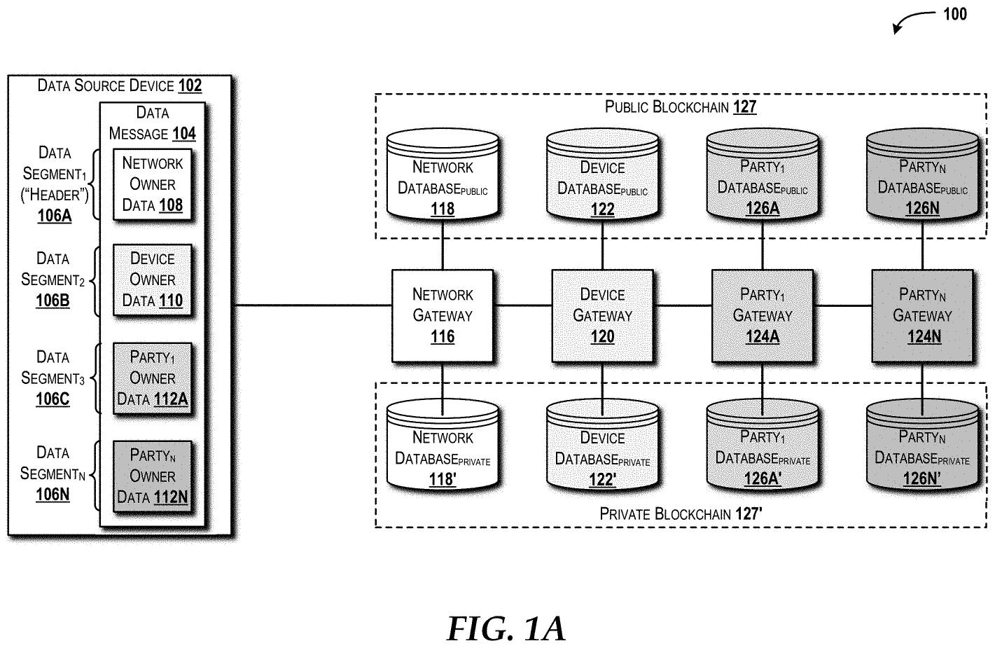

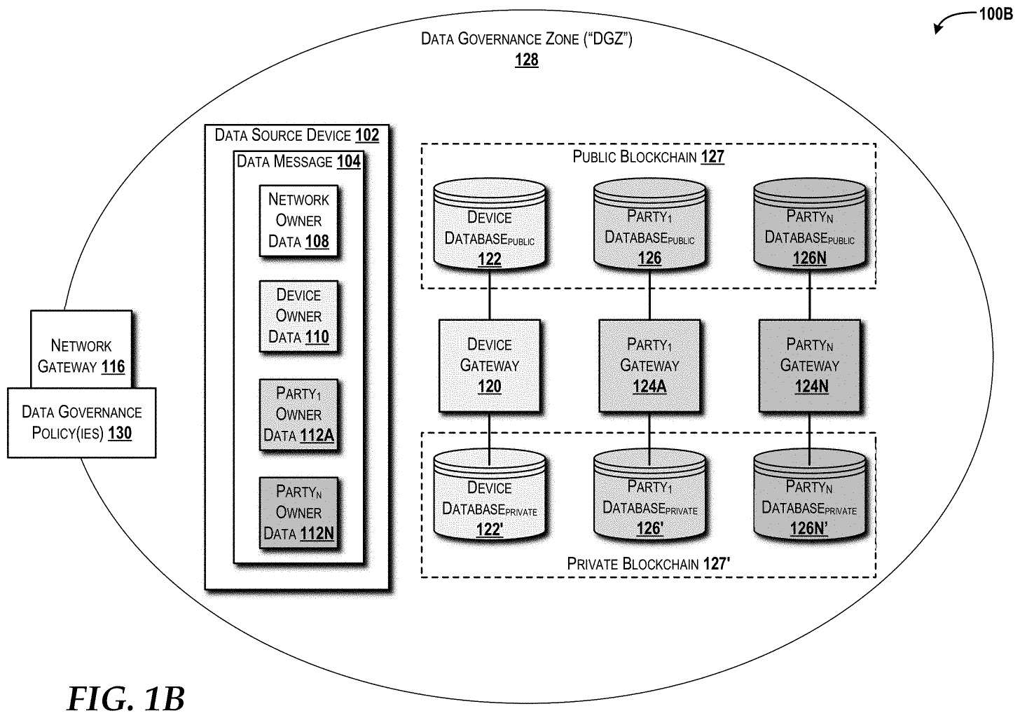

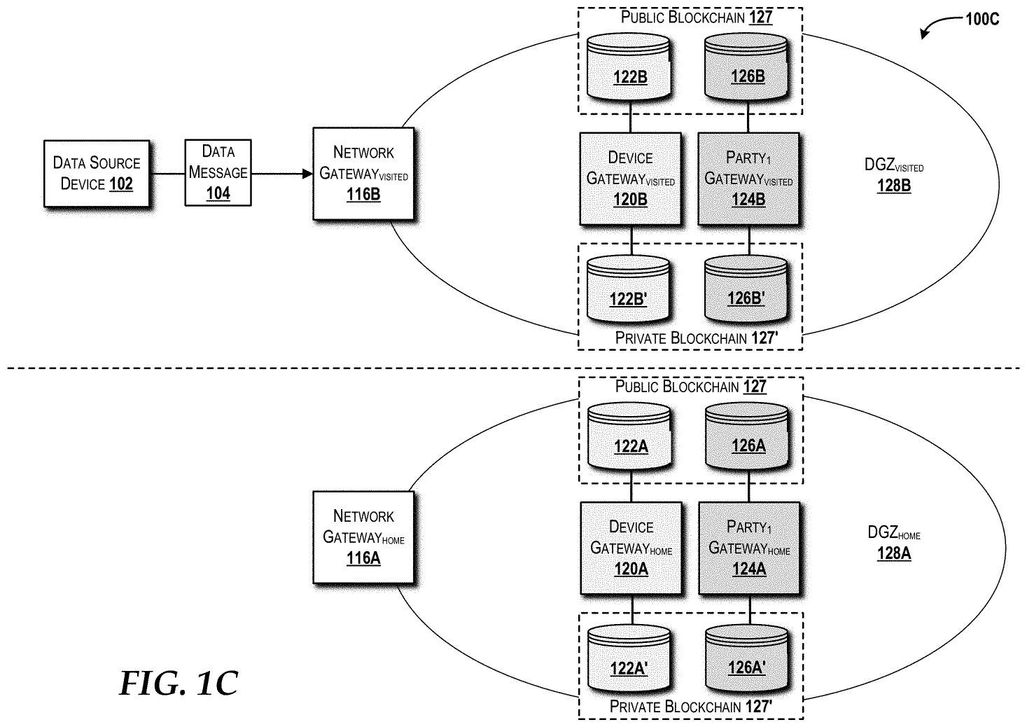

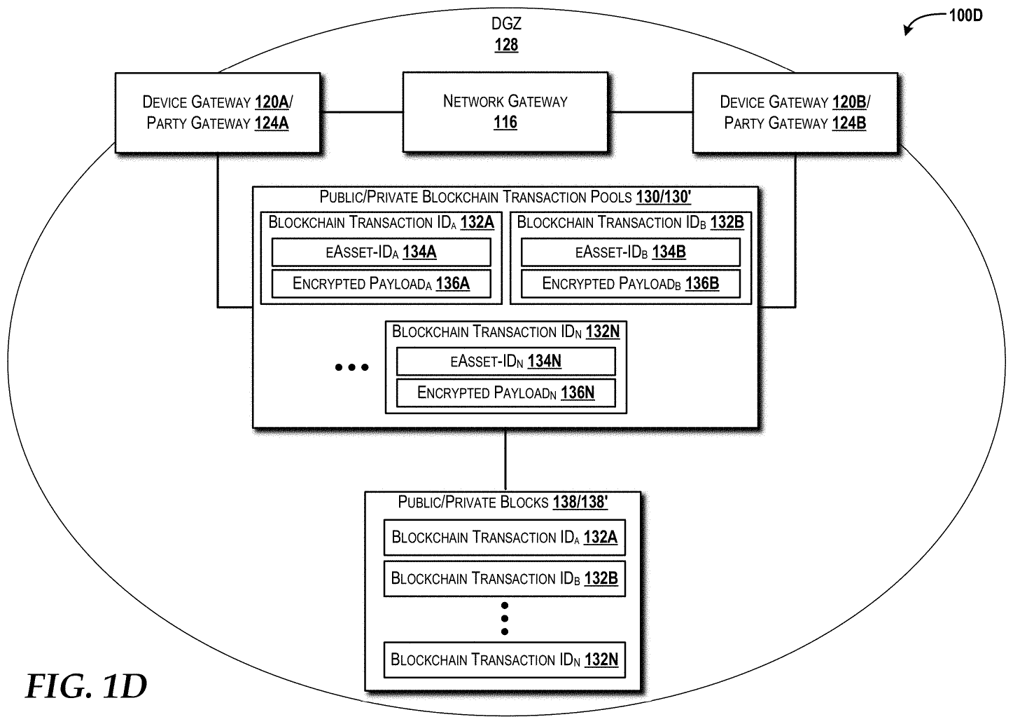

Turning now to FIG. 1A, a block diagram illustrating an operating environment 100 in which the concepts and technologies disclosed herein can be implemented will be described in accordance with exemplary embodiments. The operating environment 100 includes a data source device 102 (also referred to herein, at times, as “device 102”) that can create a multi-party data owner (“MPDO”) data message 104 (hereinafter “data message 104”) that contains a plurality of data segments 106A-106N, each of which is owned by a different party. The data message 104 can be used to provide data to any number of parties. The term “owner,” as used herein, is the party/entity within a data message flow that has proprietary ownership of one or more data segments 106 of the data message 104 generated by the data source device 102.

In the illustrated example, the data segment₁ 106A is owned by a network provider or network owner, and includes network owner data 108; the data segment₂ 106B is owned by a device manufacturer or device owner, and includes device owner data 110; and the data segment₃ through data segment₁ 106C-106N are owned by different third parties, and include party₁ owner data 112A and partyₙ owner data 112N. The data source device 102 can provide an encrypted version (not shown) of the data message 104 to each owner in a sequence, and each owner can decrypt and consume the encrypted version of their respective data segment 106. For example, the data source device 102 can send an encrypted version of the data message 104 to a network gateway 116 that can decrypt the network owner data 108 in the data segment₁ 106A using its own decryption key (the various decryption keys also are not shown), and can store the decrypted version of the network owner data 108 in a public network database 118 (illustrated as “network databasepuBuc”). The network gateway 116, in turn, can provide a modified version of the encrypted version of the data message 104 (i.e., the encrypted version of the data message 104 with the network owner data 108 removed) to a device gateway 120 that can decrypt the device owner data 110 in the data segment₂ 106B via its own decryption key, and can store the decrypted version of the device owner data 110 in a public device database 122 (illustrated as “device databasepuBuc”). The device gateway 120, in turn, can provide a modified version of the encrypted version of the data message 104 (i.e., the encrypted version of the data message 104 with the network owner data 108 and the device owner data 110 removed) to a party₁ gateway 124A that can decrypt the party₁ owner data 112A in the data segment₃ 106C via its own decryption key, and can store the decrypted version of the party₁ owner data 112A in a public party₁ database 126A (illustrated as “public party₁ databasepuBuc”). The party₁ gateway 124A, in turn, can provide a modified version of the encrypted version of the data message 104 (i.e., the encrypted version of the data message 104 with the network owner data 108, the device owner data 110, and the party₁ owner data 112A removed) to a party₁ gateway 124N that can decrypt the party₁ owner data 112N in the data segment₁ 106N via its own decryption key, and can store the decrypted version of the partyₙ owner data 112N in a public partyₙ database 126N (illustrated as “public partyₙ databasepuBuc”). Each of the databases 118, 122, and 126-126N is illustrated as having a public version (illustrated as databasespuBuc 118, 122, and 126-126N) and a private version (illustrated as databases_{PRIVATE} 118′, 122′, and 126′-126N′). The public versions are shown as part of a public blockchain 127. The private versions are shown as part of a private blockchain 127′. In some embodiments, the private blockchain 127′ is a sidechain of a main blockchain (e.g., the public blockchain 127).

It should be understood that ownership of the data does not need to be coextensive with ownership of a particular device, system, gateway, platform, network element, or the like. For example, the network owner data 108 may be utilized by the network gateway 116, but the owner of the network owner data 108 may not actually own the network gateway 116. Instead, the network gateway 116 may be owned by some other entity and only authorized to handle the network owner data 108, such as part of a lease agreement, service agreement, or the like. For ease of description, however, ownership of the network owner data 108 and the network gateway 116 will be described as coextensive, and similarly, ownership of the device owner data 110 and the device gateway 120, ownership of the party₁ owner data 112A and the party₁ gateway 124A, and ownership of the partyₙ owner data 112N and the partyₙ gateway 124N will each be described as coextensive. This should not be construed as being limiting in any way.

It also should be understood that the network gateway 116, the device gateway 120, the party₁ gateway 124A, the partyₙ gateway 124N, the party₁ database 126A, and the partyₙ database 126N may be described, at times, as being located in a “home” or “visited” location. These elements are labeled differently in the drawings using the “home” or “visited” descriptor in subscript. In the specification, these elements are labeled using the “home” or “visited” descriptor for the network gateway 116, the device gateway 120, and so on. The numerals remain the same throughout with the addition of a letter to further distinguish between “home” and “visited”. For example, the network gateway 116 introduced in FIG. 1A is introduced as a home network gateway 116A instance and a visited network gateway 116B instance in FIG. 1C.

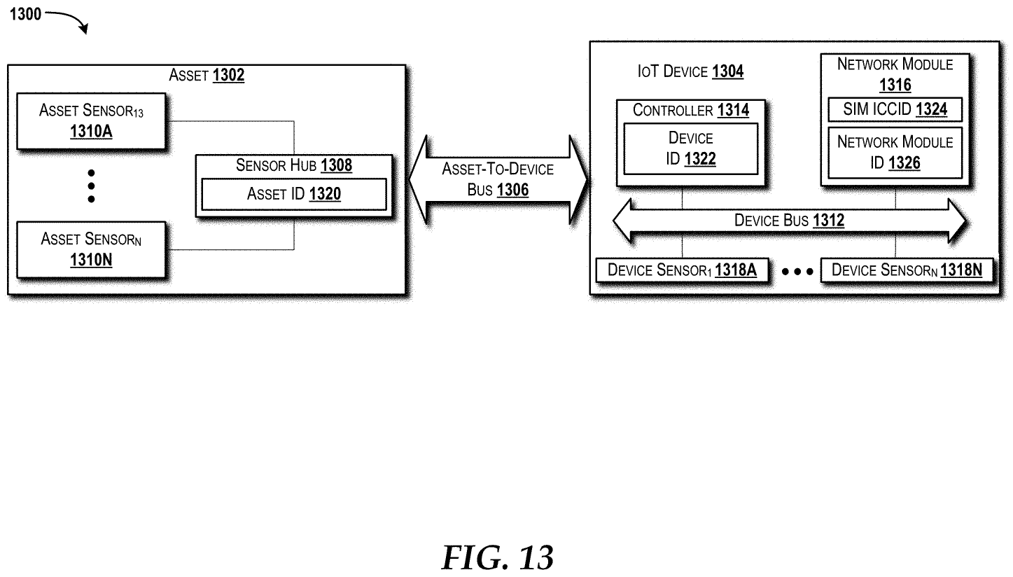

The data source device 102 can be any type of device that is capable of generating and/or collecting data (e.g., from one or more sensors such as the sensors shown in FIG. 13). The data can be owned by a plurality of owners as described above. In some embodiments, the data source device 102 is or includes an IoT device, a non-limiting example of which is illustrated and described with reference to an IoT device 1304 in FIG. 13. The data source device 102 can be a non-programmable or programmable IoT device. In some embodiments, the data source device 102 is or includes a combination of an IoT device and an asset (e.g., the IoT device 1304 and an asset 1302 best shown in FIG. 13) of some sort. An example of a combined IoT device and asset also is described with reference to FIG. 13 as a combination data source device 1300 (also referred to herein, at times, as a “device+asset”).

An asset can be an autonomous agent that meets the definition of a “machine” in accordance with machine-to-machine (“M2M”) standards. As such, the asset can be a computing element with a network interface. The asset alternatively can be or can include, but is not limited to, a product or good, a box that contains one or more products/goods, a cargo box that contains one or more products/goods, a pallet that contains one or more cargo boxes, a container that contains at least one pallet, or any other storage and/or shipping configuration. The type of asset should not be limited in any way. Other assets can be associated with smart technologies, such as smart buildings, smart cities, smart health, smart manufacturing, smart factories, and the like, among other concepts associated with the fourth industrial revolution (also known as “Industry 4.0”). In some instances, an asset can be an individual or group of individuals. The type of asset should not be limited in any way. Moreover, the industries to which the concepts and technologies disclosed herein may be applied should not be limited in any way.

The disclosed blockchain solution allows devices and assets to be provisioned separately, wherein each device and asset has a unique and anonymous blockchain identification number (referred to herein as an “eAsset-ID”), and an allocation of replenishable digital currency amounts that can be used within a blockchain network for creating digital transactions. eAsset-IDs can be created separately for both a public blockchain 127 and a private blockchain 127′ (referred to herein, respectively as public eAsset-IDs and private eAsset-IDs). An eAsset-ID can represent either an IoT Device (e.g., the data source device 102 or the IoT device 1304) or an IoT Asset (e.g., the asset 1302) as described above. When a device or a device+asset generates IoT data, the transmission of that data costs some amount of digital currency. By spending this digital currency against the IoT device's eAsset-ID or the IoT asset's eAsset-ID, the blockchain ledger infrastructure incorporates the IoT data into the ledger along with the amount spent. This IoT data then becomes permanently stored within the distributed ledger, and referenced by the unique eAsset-id allocated for the particular IoT device or IoT asset that generated the IoT data.

The data source device 102 can generate data for each party/data owner as the separate data segments 106A-106N. The data source device 102 can then perform a process to generate a hash of each of the data segments 106B-106N. The data source device 102 can create separate hashes for the device owner data 110, the party₁ owner data 112A, and the partyₙ owner data 112N. The data source device 102 also can create a hash of all data segments 106A-106N. The data source device 102 can generate these hashes using any hash function, including cyclic redundancy checks (“CRC”) (e.g., CRC32), checksum functions, and cryptographic hash functions. After the data source device 102 generates the hashes, the data source device 102 can encrypt the data segments 106A-106N. The data source device 102 also can create a message footer (not shown) that includes a combination of the hashes.

The data source device 102 can then assemble the data message 104. The data segment₁ 106A can be or can include a message header to be used by the network gateway 116 for routing the data message 104, for example, to the network gateway 116, which can decrypt the network owner data 108 (e.g., routing data) using its own decryption key. The other parties can use their respective gateways 120, 124A, 124N to generate a new header to route the data message 104 to the next stop in the message flow sequence. The data source device 102 can add a message footer to the data message 104 to complete the message assembly process.

After the data message 104 is assembled, the data source device 102 can route the data message 104 to the network gateway 116. The network gateway 116 is the only entity along the data message flow that is allowed to intercept the data message 104 before the device owner (via the device gateway 120). In some embodiments, the network gateway 116 is a federation platform with each of the other gateways—for example, the device gateway 120, the party₁ gateway 124A, and the partyₙ gateway 124N—operating as enterprise edge platforms (“EEP”) individually owned by a different enterprise. The EEPs provide a hosted, enterprise-specific data exchange that functions as a bridge between a public blockchain and a private pegged side chain, implemented.

Each of the gateways 114, 120, 124A, 124N can receive the data message 104 in sequence of a data message flow, consume the routing header (e.g., the network owner data 108 for the network gateway 116, and a new routing header for each additional participating gateway in the sequence), use the respective decryption keys to decrypt the respective data segments 106A-106N, and generate a hash (e.g., CRC32 or other described above) of the respective decrypted version of the data segments 106A-106N. Each gateway 114, 120, 124A, 124N can then acknowledge the data message 104 (e.g., via an ACK message), and can include the newly-generated hash in the ACK message. If a downstream party acknowledges the data message 104 with a hash, the data message 104 can be considered verified and can be passed to the next party upstream (e.g., the device gateway 120 to the party₁ gateway 124A, and so on in the sequence). The sequence can be determined by the device owner associated with the device gateway 120. In the illustrated example, the sequence of the network gateway 116 to the device gateway 120, the device gateway 120 to the party₁ gateway 124, and the party₁ gateway 124A to the partyₙ gateway 124N should not be construed as being limiting in any way.

Turning now to FIG. 1B, an operating environment 100B is shown with the data source device 102 operating within a data governance zone (“DGZ”) 128 will be described, according to an exemplary embodiment. The DGZ 128 is a geographically-bounded region defined in accordance with one or more data governance policies 130. The data governance policies 130 can be based upon laws, regulations, executive orders, and/or other directives established by government, enterprise, individual, regulatory committee, bureau, agency, multiples thereof, combinations thereof, and/or the like. The data governance policies 130 can define the geographical scope of the DGZ 128. In addition, the data governance policies 130 can define the data (e.g., in terms of data type, source, destination, and/or other criteria) that can be exchanged within the DGZ 128, such as from the data source device 102 to the device gateway 120, the party₁ gateway 124A, and/or the partyₙ gateway 124N.

In general, the data governance policy 130 can define the DGZ 128 as a geographical area of any size and shape. The geographical area may be contiguous, such as between two countries across a shared border. The geographical area may be noncontiguous. For example, a company may operate in multiple countries that do not share a border (e.g., United States and China), and as such, the DGZ 128 may be defined as the area within the national borders of each country. Moreover, one data governance policy 130 may define the DGZ 128 as a contiguous portion of supply chain, such as across the shared border between China and Kazakhstan, and also a noncontiguous portion defined as the area within the borders of the United States.

The DGZ 128 can be local, regional, or global. In some embodiments, the DGZ 128 follows an existing border that separates geographical areas such as towns, cities, counties, states, provinces, or countries. Alternatively, the DGZ 128 can be established for specific buildings or other places (e.g., outdoor venues). Moreover, the DGZ 128 can be established for specific entities such as a business, government, or law enforcement entity. The DGZ 128 can apply to specific industries that consider the data governance policies 130 from a plurality of sources along a supply chain (e.g., from manufacturing to shipping and to deployment.)

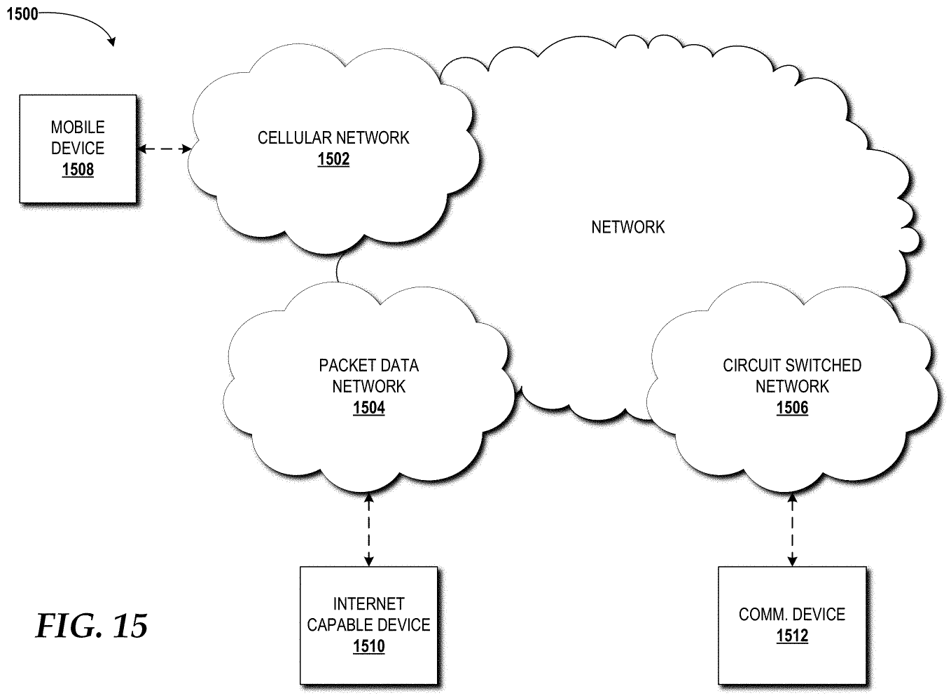

The DGZ 128 can be defined based upon an existing infrastructure such as a telecommunications or a utility infrastructure. A mobile network is one non-limiting example of an existing infrastructure upon which the DGZ 128 can be defined. The mobile network can be operated, at least in part, by one or more mobile network operators (“MNOs”). The mobile network can utilize a number of cell-sites that can be uniquely identified by cell-IDs. These cell-IDs can be used to define the geographical area encompassed by the DGZ 128. This can be particularly useful for noncontiguous DGZs 128, although contiguous DGZs 128 may also benefit from such definitions. A high-level example of a network that includes an example mobile/cellular network is illustrated and described herein with reference to FIG. 15.

The DGZ 128 can implement the network gateway 116 as the gate-keeper/entry point to the DGZ 128. As mentioned above, the network gateway 116 can enforce one or more of the data governance policies 130 to ensure the exchange of data within the DGZ 128 is in compliance.

Turning now to FIG. 1C, an operating environment 100C shown in a configuration of the data source device 102 operating in communication a visited network gateway 116B (illustrated as “network gateway_{VISITED}”) for access to a visited DGZ 128B (illustrated as “DGZ_{VISITED}”) will be described, according to an exemplary embodiment. The operating environment 100C also include a home DGZ 128A (illustrated as “DGZ_{HOME}”). The home DGZ 128A includes a home device gateway 120A (illustrated as “device gateway_{HOME}”) and a home party₁ gateway 124A (illustrated as “party₁ gateway_{HOME}”). These gateways operate in communication with corresponding databases, including a home device database 122A/122A′ and a home party₁ database 126A/126A′ operating in the public/private blockchain 127/127′. The visited DGZ 128B also includes a visited device gateway 120B (illustrated as “device gateway_{VISITED}”) and a visited party₁ gateway 124B (illustrated as “party₁ gateway_{VISITED}”). These gateways operate in communication with corresponding databases, including a visited device database 122B/122B′ and a visited party₁ database 126B/126B′ operating in the public/private blockchain 127/127′.

Turning now to FIG. 1D, an operating environment 100D that includes a public blockchain transaction pool (otherwise known as a “memory pool” or “mempool”) 130 and a private blockchain transaction pool 130′ will be described, according to an illustrative embodiment. The public blockchain transaction pool 130 is associated with the public blockchain 127. The private blockchain transaction pool 130′ is associated with the private blockchain 127′. The operating environment 100D illustrates the DGZ 128, the network gateway 116 the device gateways 120A/120B, and the party gateways 124A/124B described above. The device gateways 120A/120B and the party gateways 120B are shown in communication with the network gateway 116 and the blockchain transaction pools 130/130′.

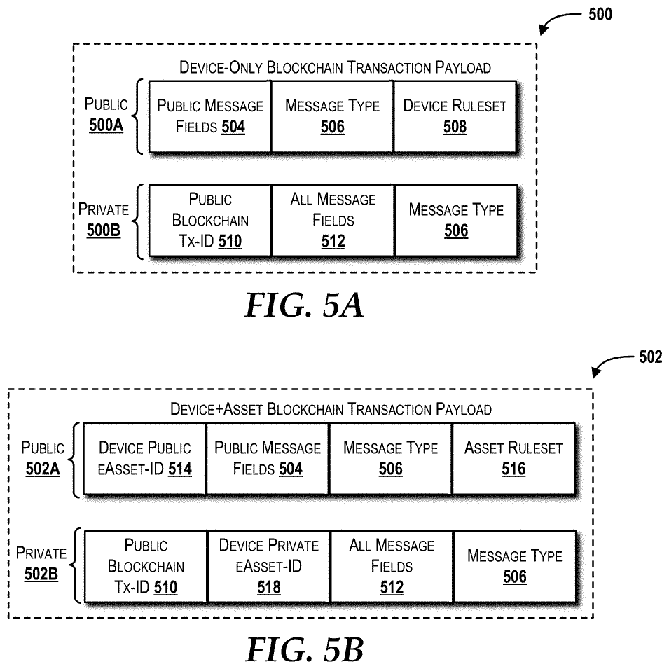

All transactions on the public blockchain 127 within the DGZ 128 move through the public blockchain transaction pool 130. All transactions on the private blockchain 127′ for each individual enterprise within the DGZ 128 move through the enterprise's instance of the private blockchain transaction pool 130′. Each blockchain transaction within the blockchain transaction pools 130/130′ can be identified by a unique blockchain transaction ID 132. Each blockchain transaction can contain one or more eAsset-IDs 134 and an encrypted payload 136. An example device-only blockchain transaction payload 500 and an example device+asset blockchain transaction payload are shown in FIGS. 5A and 5B, respectively.

The illustrated example shows both blockchain transaction pools 130/130′ including blockchain transaction associated with a blockchain transaction IDA 132A, a blockchain transaction ID_{B} 132B, and a blockchain transaction ID_{N} 132N. These transactions contain respective eAsset-IDs 134 and encrypted payloads 136. In particular, a first blockchain transaction associated with the blockchain transaction IDA 132A contains an eAsset-IDA 134A and an encrypted payload_{A} 136A; a second blockchain transaction associated with the blockchain transaction ID_{B} 132B contains an eAsset-ID_{B} 134B and an encrypted payload_{B} 136B; and a third blockchain transaction associated with the blockchain transaction ID_{N} 132N contains an eAsset-ID_{N} 134N and an encrypted payload_{N} 136N. Although these blockchain transactions are illustrated as part of the collective blockchain transaction pools 130/130′, it should be understood that this is merely for ease of illustration and the blockchain transactions may be stored in either the public blockchain transaction pool 130 or the private blockchain transaction pool 130′ prior to being written to either the public blockchain 127 or the private blockchain 127′.

Each blockchain transaction is verified by the device gateway 120A/120B and/or the party gateways 124A/124B (as the case may be) prior to being written to a public block 138 or a private block 138′ within the public or private blockchain 127/127′, respectively. In order to enter the blockchain transaction pool 130/130′, all blockchain transactions are processed through a digital currency verification, relying on currency amount, spent, unspent, input and output currency transactions associated therewith. This verification optionally may also include syntactic verification, transaction history, transaction size, currency range, timestamp, nonstandard syntactic patterns, referenced outputs in the public blockchain transaction pool 130 or the private blockchain transaction pool 130′, and/or referenced outputs in either the public blockchain 127 or the private blockchain 127′. In accordance with the concepts and technologies disclosed herein, additional verification can be provided via a smart contract as described in the methods 1000, 1100, 1200. This should not limit or restrict additional verification processes, procedures, and/or methods. As such, this example should not be construed as being limiting in any way. After a blockchain transaction has entered the blockchain transaction pool 130, the blockchain transaction can be broadcast and becomes available to all participating device gateways 120A/120B and party gateways 124A/124B operating within the DGZ 128.

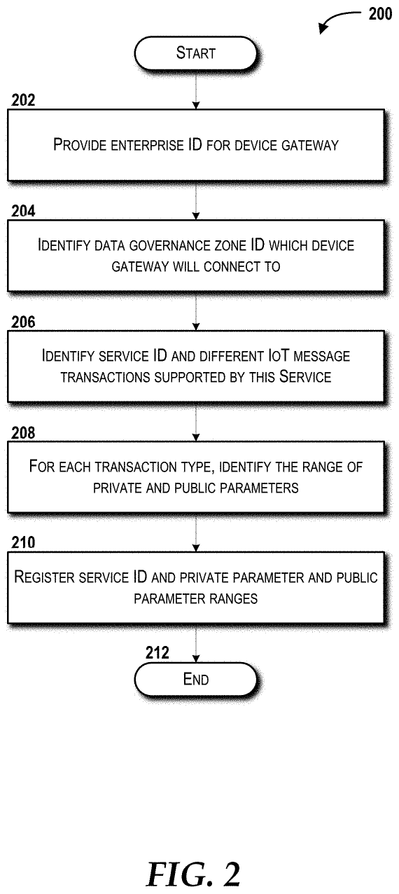

Turning now to FIG. 2, a method 200 for provisioning a new enterprise edge gateway (e.g., the device gateway 120) will be described, according to an illustrative embodiment. The method 200 will be described with reference to FIG. 2 and additional reference to FIG. 1.

It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device to perform one or more operations, and/or causing the processor to direct other components of the computing system or device to perform one or more of the operations.

For purposes of illustrating and describing the concepts of the present disclosure, operations of the methods disclosed herein are described as being performed by the data source device 102, the network gateway 116 (home or visited), the device gateway 120 (home or visited), the party₁ gateway 124A (home or visited), and/or the partyₙ gateway 124N (home or visited). In some embodiments, the functionality of two or more of the gateways disclosed herein can be combined. For example, the functionality of the network gateway 116 can be combined with the functionality of the device gateway 120. It should be understood that additional and/or alternative devices, servers, computers, and/or network nodes can provide the functionality described herein via execution of one or more modules, applications, and/or other software. Thus, the illustrated embodiments are illustrative, and should not be viewed as being limiting in any way.

The method 200 begins and proceeds to operation 202. At operation 202, the network gateway 116 provides an enterprise ID for the device gateway 120. The enterprise ID can be any unique identifier to uniquely identify different enterprise edge gateways, such as the device gateway 120 and the party_{1-N} gateways 124A-124N from each other. The method 200 is described with the enterprise edge gateway embodied as the device gateway 120. It should be understood, however, that the operations of the method 200 can be applied equally to other enterprise edge gateways, such as one or more third party gateways 124.

From operation 202, the method 200 proceeds to operation 204. At operation 204, the network gateway 116 identifies a DGZ ID of the DGZ 128 to which the device gateway 120 will connect. From operation 204, the method 200 proceeds to operation 206. At operation 206, the network gateway 116 identifies a service ID of a service supported by the device gateway 120. The network gateway 116 also identifies one or more IoT message transaction types that are supported by the service.

From operation 206, the method 200 proceeds to operation 208. At operation 208, for each transaction type, the network gateway 116 identifies a range of private and public parameters. From operation 208, the method 200 proceeds to operation 210. At operation 210, the network gateway 116 registers the service ID and the private and public parameter ranges.

From operation 210, the method 200 proceeds to operation 212. At operation 212, the method 200 ends.

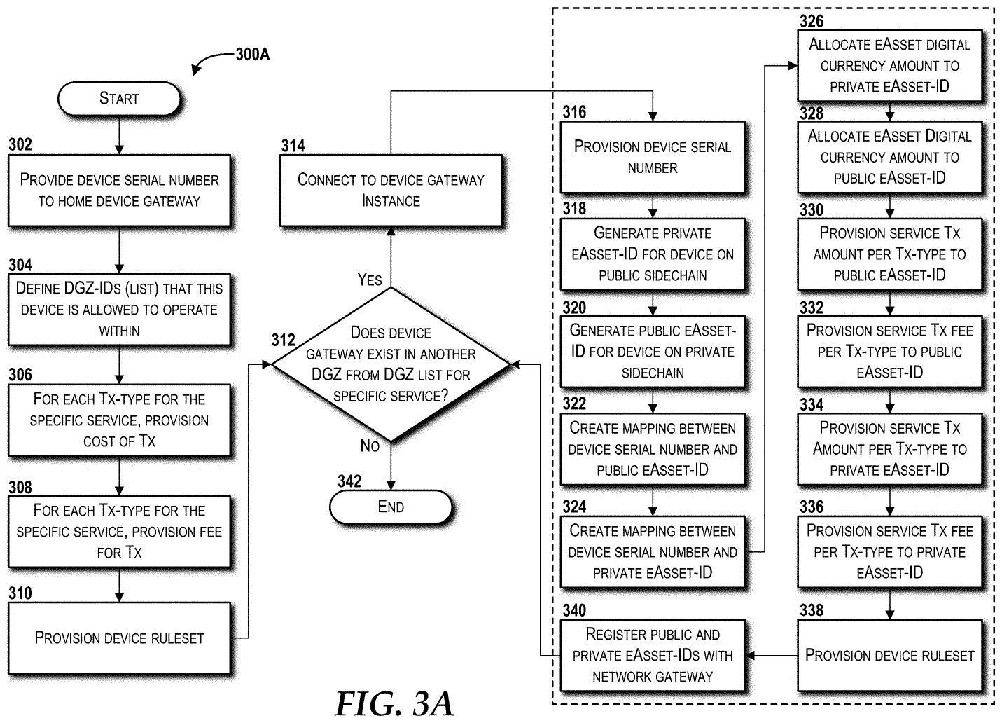

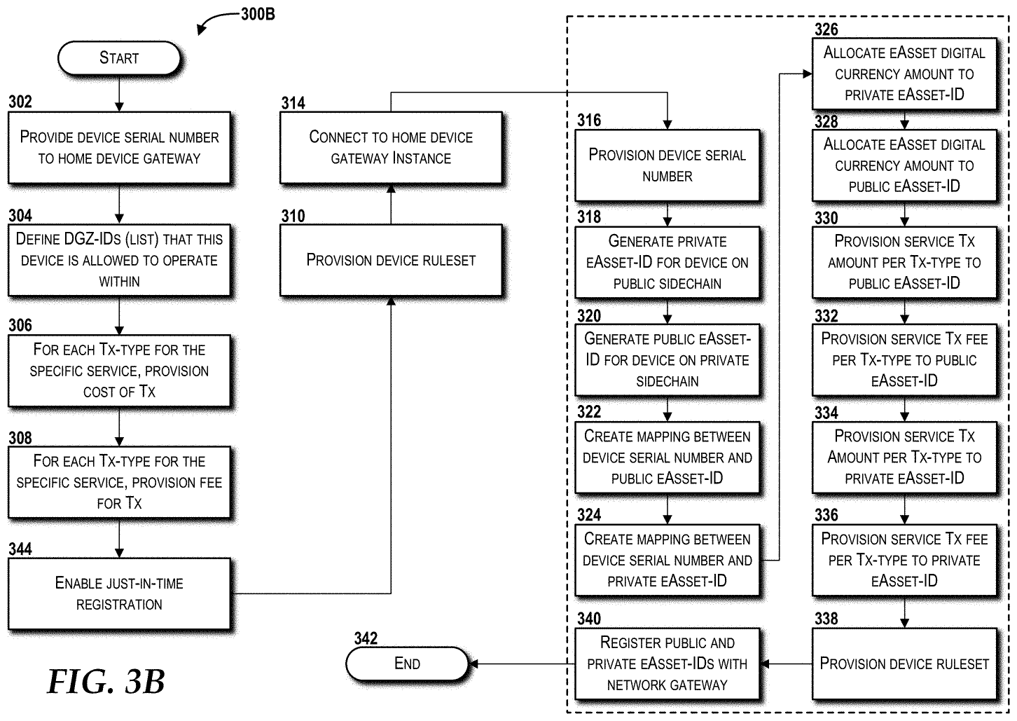

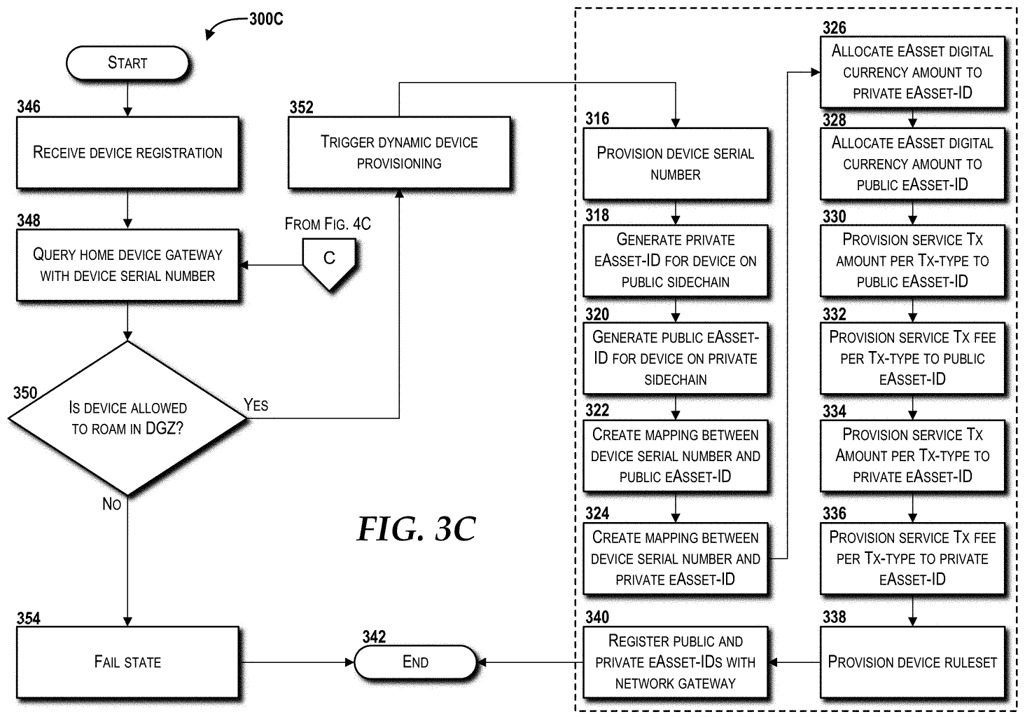

Turning now to FIG. 3A, a method 300A for network provisioning of a new device for operation will be described, according to an illustrative embodiment. The method 300A begins and proceeds to operation 302. At operation 302, the network gateway 116 provides a device serial number to the home device gateway 120A (i.e., the device gateway 120 operating in the home DGZ 128A of the device 102). From operation 302, the method 300A proceeds to operation 304. At operation 304, the network gateway 116 defines a list of DGZ-IDs that the device 102 is allowed to operate within.

From operation 304, the method 300A proceeds to operation 306. At operation 306, the network gateway 116 provisions a transaction cost for each transaction type and for the specific service. From operation 306, the method 300A proceeds to operation 308. At operation 308, the network gateway 116 provisions a transaction fee for each transaction type and for the specific service.

From operation 308, the method 300A proceeds to operation 310. At operation 310, the network gateway 116 provisions a device ruleset 508 (best shown in FIG. 5A). From operation 310, the method 300A proceeds to operation 312. At operation 312, the network gateway 116 determines if the device gateway 120 exists in another DGZ 128 from the DGZ list for the specific service. If so, the method 300 proceeds to operation 314. At operation 314, the network gateway 116 connects to the device gateway 120 (e.g., a home or a visited device gateway 120 instance). From operation 314, the method 300 proceeds to operation 316.

At operation 316, the device gateway 120 provisions the device serial number associated with the device 102. From operation 316, the method 300A proceeds to operation 318. At operation 318, the device gateway 120 generates a private eAsset-ID for the device 102 (best shown in FIG. 5 as device private eAsset-ID 518) on the public blockchain 127. From operation 318, the method 300A proceeds to operation 320. At operation 320, the device gateway 120 generates a public eAsset-ID (best shown in FIG. 5 as device public eAsset-ID 514) for the device 102 on the private blockchain 127′.

From operation 320, the method 300A proceeds to operation 322. At operation 322, the device gateway 120 creates a mapping between the device 102 serial number and the device public eAsset-ID 514. From operation 322, the method 300A proceeds to operation 324. At operation 324, the device gateway 120 creates a mapping between the device serial number and the device private eAsset-ID 518.

From operation 324, the method 300A proceeds to operation 326. At operation 326, the device gateway 120 allocates a digital currency amount to the device private eAsset-ID 518. From operation 326, the method 300A proceeds to operation 328. At operation 328, the device gateway 120 allocates a digital currency amount to the device public eAsset-ID 514.

From operation 328, the method 300 proceeds to operation 330. At operation 330, the device gateway 120 provisions a service transaction cost per transaction-type to the device public eAsset-ID 514. From operation 330, the method 300A proceeds to operation 332. At operation 332, the device gateway 120 provisions a service transaction fee per transaction-type to the device public eAsset-ID 514.

From operation 332, the method 300A proceeds to operation 334. At operation 334, the device gateway 120 provisions a service transaction cost per transaction-type to the device private eAsset-ID 518. From operation 334, the method 300A proceeds to operation 336. At operation 336, the device gateway 120 provisions a service transaction fee per transaction-type to the device private eAsset-ID 518.

From operation 336, the method 300A proceeds to operation 338. At operation 338, the device gateway 120 provisions the device ruleset 508 for the device 102. From operation 338, the method 300A proceeds to operation 340. At operation 340, the device gateway 120 registers the device public eAsset-ID 514 and the device private eAsset-ID 518 with the network gateway 116.

From operation 340, the method 300A returns to operation 312. At operation 312, the network gateway 116 determines if the device gateway 120 exists in another DGZ 128 from the DGZ list for the specific service. If so, the method proceeds to operation 314, and the method 300A proceeds as described above. The operations 312 through 340 repeat for all DGZs 128 in the DGZ list for the specific service. If, however, at operation 312, the network gateway 116 determines that the device gateway 120 does not exist in another DGZ 128 from the DGZ list for the specific service, the method 300A proceeds to operation 342. At operation 342, the method 300A can end.

Turning now to FIG. 3B, a method 300B for just-in-time network provisioning of a new device for operation will be described, according to an illustrative embodiment. The method 300B begins and proceeds to operation 302. At operation 302, the network gateway 116 provides a device serial number to the home device gateway 120A (i.e., the device gateway 120 operating in the home DGZ 128A of the device 102. From operation 302, the method 300B proceeds to operation 304. At operation 304, the network gateway 116 defines a list of DGZ-IDs that the device 102 is allowed to operate within.

From operation 304, the method 300B proceeds to operation 306. At operation 306, the network gateway 116 provisions a transaction cost for each transaction type and for the specific service. From operation 306, the method 300B proceeds to operation 308. At operation 308, the network gateway 116 provisions a transaction fee for each transaction type and for the specific service.

From operation 308, the method 300 proceeds to operation 344. At operation 344, the network gateway 116 enables just-in-time provisioning. From operation 344, the method 300 proceeds to operation 314. At operation 314, the network gateway 116 connects to the device gateway 120 (e.g., the home or a visited device gateway 120 instance).

From operation 314, the method 300 proceeds to operation 316. At operation 316, the device gateway 120 provisions the device serial number associated with the device 102. From operation 316, the method 300B proceeds to operation 318. At operation 318, the device gateway 120 generates a private eAsset-ID for the device 102 (best shown in FIG. 5 as device private eAsset-ID 518) on the public blockchain 127. From operation 318, the method 300B proceeds to operation 320. At operation 320, the device gateway 120 generates a public eAsset-ID for the device 102 (best shown in FIG. 5 as device public eAsset-ID 514) on the private blockchain 127′.

From operation 320, the method 300B proceeds to operation 322. At operation 322, the device gateway 120 creates a mapping between the device serial number and the device public eAsset-ID 514. From operation 322, the method 300B proceeds to operation 324. At operation 324, the device gateway 120 creates a mapping between the device serial number and the device private eAsset-ID 518.

From operation 324, the method 300B proceeds to operation 326. At operation 326, the device gateway 120 allocates a digital currency amount to the device private eAsset-ID 518. From operation 326, the method 300B proceeds to operation 328. At operation 328, the device gateway 120 allocates a digital currency amount to the device public eAsset-ID 514.

From operation 328, the method 300 proceeds to operation 330. At operation 330, the device gateway 120 provisions a service transaction cost per transaction-type to the device public eAsset-ID 514. From operation 330, the method 300B proceeds to operation 332. At operation 332, the device gateway 120 provisions a service transaction fee per transaction-type to the device public eAsset-ID 514.

From operation 332, the method 300B proceeds to operation 334. At operation 334, the device gateway 120 provisions a service transaction cost per transaction-type to the device private eAsset-ID 518. From operation 334, the method 300B proceeds to operation 336. At operation 336, the device gateway 120 provisions a service transaction fee per transaction-type to the device private eAsset-ID 518.

From operation 336, the method 300B proceeds to operation 338. At operation 338, the device gateway 120 provisions the device ruleset 508 for the device 102. From operation 338, the method 300B proceeds to operation 340. At operation 340, the device gateway 120 registers the device public eAsset-ID 514 and the device private eAsset-ID 518 with the network gateway 116.

From operation 340, the method 300B proceeds to operation 342. The method 300B can end at operation 342.

Turning now to FIG. 3C, a method 300C for dynamic just-in-time network provisioning of a new device 102 for operation in a visited DGZ 128B will be described, according to an illustrative embodiment. The method 300C begins and proceeds to operation 346. At operation 346, the network gateway 116 receives a device registration. From operation 346, the method 300 proceeds to operation 348. At operation 348, the network gateway 116 queries the home device gateway 120A with the device serial number.

From operation 348, the method 300 proceeds to operation 350. At operation 350, the network gateway 116 determines, based upon a query response from the home device gateway 120A, whether the device 102 is allowed to roam in the visited DGZ 128B. If so, the method 300C proceeds to operation 352. At operation 352, the network gateway 116 triggers dynamic just-in-time device provisioning to provision the visited device gateway 120B operating in the visited DGZ 128B.

From operation 352, the method 300C proceeds to operation 316. At operation 316, the device gateway 120 provisions the device serial number associated with the device 102. From operation 316, the method 300C proceeds to operation 318. At operation 318, the device gateway 120 generates a private eAsset-ID for the device 102 (best shown in FIG. 5 as device private eAsset-ID 518) on the public blockchain 127. From operation 318, the method 300C proceeds to operation 320. At operation 320, the device gateway 120 generates a public eAsset-ID for the device 102 (best shown in FIG. 5 as device public eAsset-ID 514) on the private blockchain 127′.

From operation 320, the method 300C proceeds to operation 322. At operation 322, the device gateway 120 creates a mapping between the device serial number and the device public eAsset-ID 514. From operation 322, the method 300C proceeds to operation 324. At operation 324, the device gateway 120 creates a mapping between the device serial number and the device private eAsset-ID 518.

From operation 324, the method 300C proceeds to operation 326. At operation 326, the device gateway 120 allocates a digital currency amount to the device private eAsset-ID 518. From operation 326, the method 300C proceeds to operation 328. At operation 328, the device gateway 120 allocates a digital currency amount to the device public eAsset-ID 514.

From operation 328, the method 300 proceeds to operation 330. At operation 330, the device gateway 120 provisions a service transaction cost per transaction-type to the device public eAsset-ID 514. From operation 330, the method 300C proceeds to operation 332. At operation 332, the device gateway 120 provisions a service transaction fee per transaction-type to the device public eAsset-ID 514.

From operation 332, the method 300C proceeds to operation 334. At operation 334, the device gateway 120 provisions a service transaction cost per transaction-type to the device private eAsset-ID 518. From operation 334, the method 300C proceeds to operation 336. At operation 336, the device gateway 120 provisions a service transaction fee per transaction-type to the device private eAsset-ID 518.

From operation 336, the method 300C proceeds to operation 338. At operation 338, the device gateway 120 provisions the device ruleset 508 for the device 102. From operation 338, the method 300C proceeds to operation 340. At operation 340, the device gateway 120 registers the device public eAsset-ID 514 and the device private eAsset-ID 518 with the network gateway 116.

From operation 340, the method 300C proceeds to operation 342. The method 300C can end at operation 342.

Returning to operation 350, if the network gateway 116 determines that the device 102 is not allowed to roam in the visited DGZ 128B, the method 300C proceeds to operation 354, where the device 102 registration process fails. The method 300C then proceeds to operation 342. The method 300 can end at operation 342.

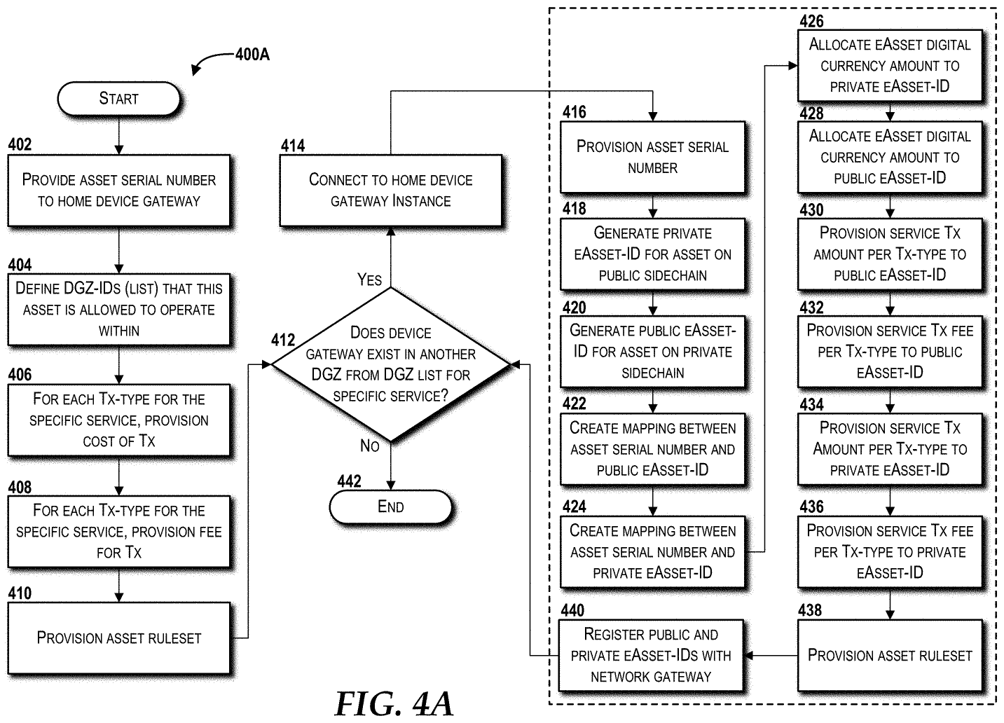

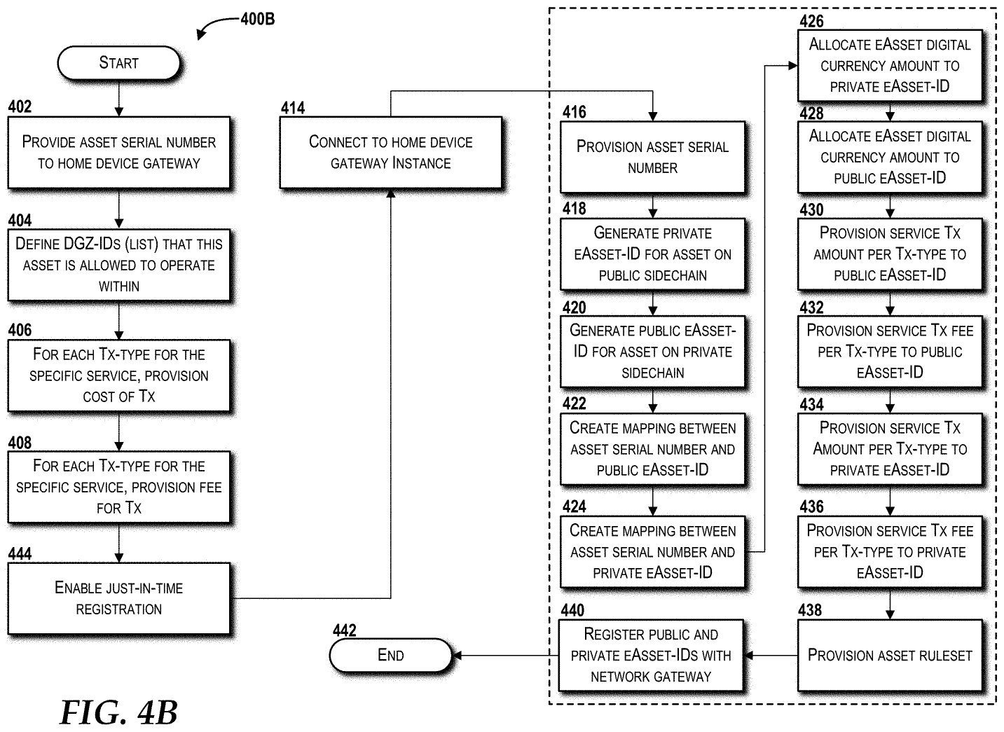

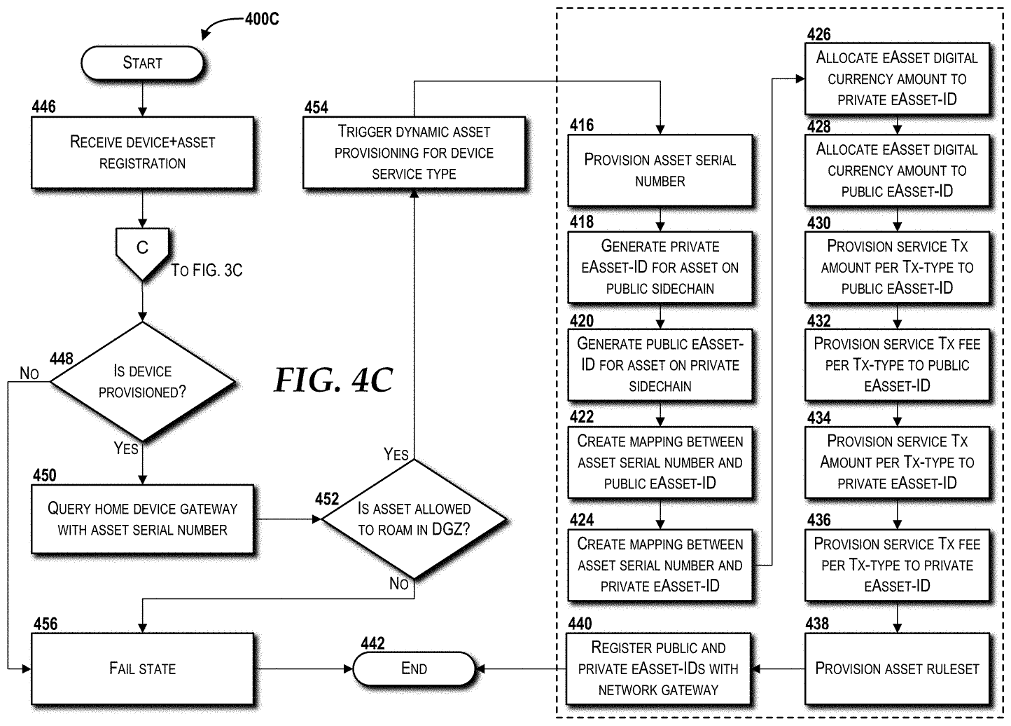

Turning now to FIG. 4A, a method 400A for network provisioning of a new asset for operation, per service type, will be described, according to an illustrative embodiment. The method 400A begins and proceeds to operation 402. At operation 402, the network gateway 116 provides an asset serial number to the home device gateway 120 (i.e., the device gateway 120 operating in the home DGZ 128A of the device 102). From operation 402, the method 400A proceeds to operation 404. At operation 404, the network gateway 116 defines a list of DGZ-IDs that the asset is allowed to operate within.

From operation 404, the method 400A proceeds to operation 406. At operation 406, the network gateway 116 provisions a transaction cost for each transaction type and for the specific service. From operation 406, the method 400A proceeds to operation 408. At operation 408, the network gateway 116 provisions a transaction fee for each transaction type and for the specific service.

From operation 408, the method 400A proceeds to operation 410. At operation 410, the network gateway 116 provisions the device ruleset 508. From operation 410, the method 400A proceeds to operation 412. At operation 412, the network gateway 116 determines if the device gateway 120 exists in another DGZ 128 from the DGZ list for the specific service. If so, the method proceeds to operation 414. At operation 414, the network gateway 116 connects to the device gateway 120 (e.g., the home or a visited device gateway 120 instance).

From operation 414, the method 400 proceeds to operation 416. At operation 416, the device gateway 120 provisions the asset serial number associated with the asset. From operation 416, the method 400A proceeds to operation 418. At operation 418, the device gateway 120 generates a private eAsset-ID for the asset 1302 on the public blockchain 127. From operation 418, the method 400A proceeds to operation 420. At operation 420, the device gateway 120 generates a public eAsset-ID for the asset 1302 on the private blockchain 127′.

From operation 420, the method 400A proceeds to operation 422. At operation 422, the device gateway 120 creates a mapping between the asset serial number and the public eAsset-ID. From operation 422, the method 400A proceeds to operation 424. At operation 424, the device gateway 120 creates a mapping between the asset serial number and the private eAsset-ID.

From operation 424, the method 400A proceeds to operation 426. At operation 426, the device gateway 120 allocates a digital currency amount to the private eAsset-ID. From operation 426, the method 400A proceeds to operation 428. At operation 428, the device gateway 120 allocates a digital currency amount to the public eAsset-ID.

From operation 428, the method 400 proceeds to operation 430. At operation 430, the device gateway 120 provisions a service transaction cost per transaction-type to the public eAsset-ID. From operation 430, the method 400A proceeds to operation 432. At operation 432, the device gateway 120 provisions a service transaction fee per transaction-type to the public eAsset-ID.

From operation 432, the method 400A proceeds to operation 434. At operation 434, the device gateway 120 provisions a service transaction cost per transaction-type to the private eAsset-ID. From operation 434, the method 400A proceeds to operation 436. At operation 436, the device gateway 120 provisions a service transaction fee per transaction-type to the private eAsset-ID.

From operation 436, the method 400A proceeds to operation 438. At operation 438, the device gateway 120 provisions the asset ruleset 516 for the asset. From operation 438, the method 400A proceeds to operation 440. At operation 440, the device gateway 120 registers the public eAsset-ID and the private eAsset-ID with the network gateway 116.

From operation 440, the method 400A returns to operation 412. At operation 412, the network gateway 116 determines if the device gateway 120 exists in another DGZ 128 from the DGZ list for the specific service. If so, the method proceeds to operation 414, and the method 400A proceeds as described above. The operations 412 through 440 repeat for all DGZs 128 in the DGZ list for the specific service. If, however, at operation 412, the network gateway 116 determines that the device gateway 120 does not exists in another DGZ from the DGZ list for the specific service, the method 400A proceeds to operation 442. At operation 442, the method 400A can end.

Turning now to FIG. 4B, a method 400B for dynamic just-in-time network provisioning of a new asset for operation, per service type, will be described, according to an illustrative embodiment. The method 400B begins and proceeds to operation 402. The method 400B begins and proceeds to operation 402. At operation 402, the network gateway 116 provides an asset serial number to the home device gateway 120 (i.e., the device gateway 120A operating in the home DGZ 128A of the device 102). From operation 402, the method 400B proceeds to operation 404. At operation 404, the network gateway 116 defines a list of DGZ-IDs that the asset is allowed to operate within.

From operation 404, the method 400B proceeds to operation 406. At operation 406, the network gateway 116 provisions a transaction cost for each transaction type and for the specific service. From operation 406, the method 400B proceeds to operation 408. At operation 408, the network gateway 116 provisions a transaction fee for each transaction type and for the specific service.

From operation 408, the method 400 proceeds to operation 444. At operation 444, the network gateway 116 enables just-in-time provisioning. From operation 444, the method 300 proceeds to operation 414. At operation 414, the network gateway 116 connects to the device gateway 120 (e.g., the home or a visited device gateway 120 instance).

From operation 414, the method 400 proceeds to operation 416. At operation 416, the device gateway 120 provisions the asset serial number associated with the asset. From operation 416, the method 400B proceeds to operation 418. At operation 418, the device gateway 120 generates a private eAsset-ID for the asset on the public blockchain 127. From operation 418, the method 400B proceeds to operation 420. At operation 420, the device gateway 120 generates a public eAsset-ID for the asset 1302 on the private blockchain 127′.

From operation 420, the method 400B proceeds to operation 422. At operation 422, the device gateway 120 creates a mapping between the asset serial number and the public eAsset-ID. From operation 422, the method 400B proceeds to operation 424. At operation 424, the device gateway 120 creates a mapping between the asset serial number and the private eAsset-ID.

From operation 424, the method 400B proceeds to operation 426. At operation 426, the device gateway 120 allocates a digital currency amount to the private eAsset-ID. From operation 426, the method 400B proceeds to operation 428. At operation 428, the device gateway 120 allocates a digital currency amount to the public eAsset-ID.

From operation 428, the method 400 proceeds to operation 430. At operation 430, the device gateway 120 provisions a service transaction cost per transaction-type to the public eAsset-ID. From operation 430, the method 400B proceeds to operation 432. At operation 432, the device gateway 120 provisions a service transaction fee per transaction-type to the public eAsset-ID.

From operation 432, the method 400B proceeds to operation 434. At operation 434, the device gateway 120 provisions a service transaction cost per transaction-type to the private eAsset-ID. From operation 434, the method 400B proceeds to operation 436. At operation 436, the device gateway 120 provisions a service transaction fee per transaction-type to the private eAsset-ID.

From operation 436, the method 400B proceeds to operation 438. At operation 438, the device gateway 120 provisions the asset ruleset 516 for the asset 1302. From operation 438, the method 400B proceeds to operation 440. At operation 440, the device gateway 120 registers the public eAsset-ID and the private eAsset-ID with the network gateway 116.

From operation 440, the method 400B proceed to operation 442. The method 400B can end at operation 442.

Turning now to FIG. 4C, a method 400C for dynamic just-in-time network provisioning of a new device+asset for operation, per service type, will be described, according to an illustrative embodiment. The method 400C begins and proceeds to operation 446. At operation 446, the network gateway 116 receives a device+asset registration. From operation 446, the method 400C proceeds to FIG. 3C, and in particular, operation 348. The method 400C proceeds as described above and returns the method 400C, and in particular, operation 448. At operation 448, the network gateway 116 determines if the device is provisioned (i.e., based on whether the method 400C returns a fail state at operation 354). If so, the method 400C proceeds to operation 450. At operation 450, the network gateway 116 queries the home device gateway 120A with the asset serial number.

From operation 450, the method 400C proceeds to operation 452. At operation 452, the network gateway 116 determines, based upon a query response from the home device gateway 120A, whether the asset is allowed to roam in the visited DGZ 128B. If so, the method 400C proceeds to operation 454. At operation 454, the network gateway 116 triggers dynamic just-in-time device provisioning to provision the visited device gateway 120B operating in the visited DGZ 128B.

From operation 454, the method 400C proceeds to operation 416. At operation 416, the device gateway 120 provisions the asset serial number associated with the asset. From operation 416, the method 400B proceeds to operation 418. At operation 418, the device gateway 120 generates a private eAsset-ID for the asset on the public blockchain 127. From operation 418, the method 400B proceeds to operation 420. At operation 420, the device gateway 120 generates a public eAsset-ID for the asset on the private blockchain 127′.

From operation 420, the method 400B proceeds to operation 422. At operation 422, the device gateway 120 creates a mapping between the asset serial number and the public eAsset-ID. From operation 422, the method 400B proceeds to operation 424. At operation 424, the device gateway 120 creates a mapping between the asset serial number and the private eAsset-ID.

From operation 424, the method 400B proceeds to operation 426. At operation 426, the device gateway 120 allocates a digital currency amount to the private eAsset-ID. From operation 426, the method 400B proceeds to operation 428. At operation 428, the device gateway 120 allocates a digital currency amount to the public eAsset-ID.

From operation 428, the method 400 proceeds to operation 430. At operation 430, the device gateway 120 provisions a service transaction cost per transaction-type to the public eAsset-ID. From operation 430, the method 400B proceeds to operation 432. At operation 432, the device gateway 120 provisions a service transaction fee per transaction-type to the public eAsset-ID.

From operation 432, the method 400B proceeds to operation 434. At operation 434, the device gateway 120 provisions a service transaction cost per transaction-type to the private eAsset-ID. From operation 434, the method 400B proceeds to operation 436. At operation 436, the device gateway 120 provisions a service transaction fee per transaction-type to the private eAsset-ID.

From operation 436, the method 400B proceeds to operation 438. At operation 438, the device gateway 120 provisions the asset ruleset 516 for the asset. From operation 438, the method 400B proceeds to operation 440. At operation 440, the device gateway 120 registers the public eAsset-ID and the private eAsset-ID with the network gateway 116.

From operation 440, the method 400B proceed to operation 442. The method 400B can end at operation 442.

Returning to operation 448, if the network gateway 116 determines that the device is not provisioned, the method 400C proceeds to operation 456. At operation 456, the device+asset registration process fails. The method 400C then proceeds to operation 442. The method 400 can end at operation 442.

Returning to operation 452, if the network gateway 116 determines that the asset is not allowed to roam in the visited DGZ 128B, the method 400C proceeds to operation 456, where the device registration process fails. From operation 456, the method 400 proceeds to operation 442. The method 400C can end at operation 442.

Turning now to FIG. 5A, a block diagram illustrating aspects of a device-only blockchain transaction payload 500 will be described, according to an illustrative embodiment. The device-only blockchain transaction payload 500 is the payload of IoT transactions that originate from the data source device 102 and terminate at the enterprise edge gateways, such as a device gateway 120 or a third party gateway 124, wherein the data source device 102 is a device-only (i.e., no asset accompanies the device). The device-only blockchain transaction payload 500 includes public and private versions, including a public device-only blockchain transaction payload 500A and a private device-only blockchain transaction payload 500B.

The public device-only blockchain transaction payload 500A can include one or more public message fields 504, a message type 506, and a device ruleset 508. The public message fields 504 can include public data contained in an IoT message such as the data message 104 (best shown in FIG. 1). The message type 506 can include meta-data to indicate the type of IoT message (e.g., sensor-data, alarm, etc.). The device ruleset 508 can include one or more rules established for the device 102.

The device ruleset 508 can include a rule type, rule name, rule value, and rule description field(s). The device ruleset 508 can include one or more rules for one or more sensors (best shown in FIG. 13—asset sensor(s) 1310 and/or device sensor(s) 1318). For example, a temperature sensor may have two rules. One rule may state that if temperature changes, the device 102 should send a notification. Another may state that the sensor accuracy is 2 degrees Celsius. A device policy can be the combination of all sensor rulesets—for example, a temperature ruleset plus a humidity ruleset plus a door open/close ruleset, or other combination as the case may be.

The example described above is an example of an event-driven policy with two rules in a temperature ruleset. If this is the only ruleset, then these two rules encompass the entirety of a device policy. The device policy is event-driven because an event, such as a change in temperature detected by a temperature sensor, causes the device 102 to send a notification. In other words, the device 102 will only send data when the policy (again the one ruleset in this example) is violated. A violation of this policy would be a temperature change exceeds plus or minus 2 degrees Celsius.

The private device-only blockchain transaction payload 500B can include a public blockchain transaction ID 510, all message fields 512, and the message type 506. The public blockchain transaction ID 510 can be generated at operation 320 and registered with the network gateway 116 at operation 340 in the methods 300A, 300B, and 300C described above (see FIGS. 3A-3C). The all message fields 512 field can include the public message fields 504 and any private message fields (not shown separately). The private message fields can include private data contained in a data message such as the data message 104 (best shown in FIG. 1). The message type 506 can identify whether the data message 104 is a device-only message or a device+asset message. The message type 506 can include meta-data to indicate the type of IoT message (e.g., sensor-data, alarm, etc.).

Turning now to FIG. 5B, a block diagram illustrating aspects of a device+asset blockchain transaction payload 502 will be described, according to an illustrative embodiment. The device+asset blockchain transaction payload 502 is the payload of IoT transactions that originate from the data source device 102 and terminate at the enterprise edge gateways, such as a device gateway 120 or a third party gateway, wherein the data source device 102 is a device+asset (best shown in FIG. 13). The device+asset blockchain transaction payload 502 includes public and private versions, including a public device+asset blockchain transaction payload 502A and a private device+asset blockchain transaction payload 500B.

The public device+asset blockchain transaction payload 502A can include one or more public message fields 504, the message type 506, a device public eAsset-ID 514, and an asset ruleset 516. The public message fields 504 can include public data contained in a data message such as the data message 104 (best shown in FIG. 1). The message type 506 can include meta-data to indicate the type of IoT message (e.g., sensor-data, alarm, etc.). The device public eAsset-ID 514 can uniquely identify the device 102 for use in transactions on the public blockchain 127. The asset ruleset 516 can include one or more rules established, for example, during one of the methods 400A, 400B, or 400C described above (see FIGS. 4A-4C).

The private device+asset blockchain transaction payload 502B can include the public blockchain transaction ID 510, the all message fields 512, a device private eAsset-ID 518, and the message type 506. The public blockchain transaction ID 510 can be generated at operation 420 and registered with the network gateway 116 at operation 440 in the methods 400A, 400B, and 400C described above (see FIGS. 4A-4C). The all message fields 512 field can include the public message fields 504 and any private message fields (not shown separately). The private message fields can include private data contained in a data message such as the data message 104 (best shown in FIG. 1). The device private eAsset-ID 518 can uniquely identify the device 102 for use in transactions on the private blockchain 127′. The message type 506 can include meta-data to indicate the type of IoT message (e.g., sensor-data, alarm, etc.).

The terms “public blockchain transaction payload” and “private blockchain transaction payload” are used herein to refer to blockchain transaction payloads on the public blockchain 127 and the private blockchain 127′, respectively. Moreover, these terms may refer to a device-only, a device+asset, or both, unless otherwise specified.

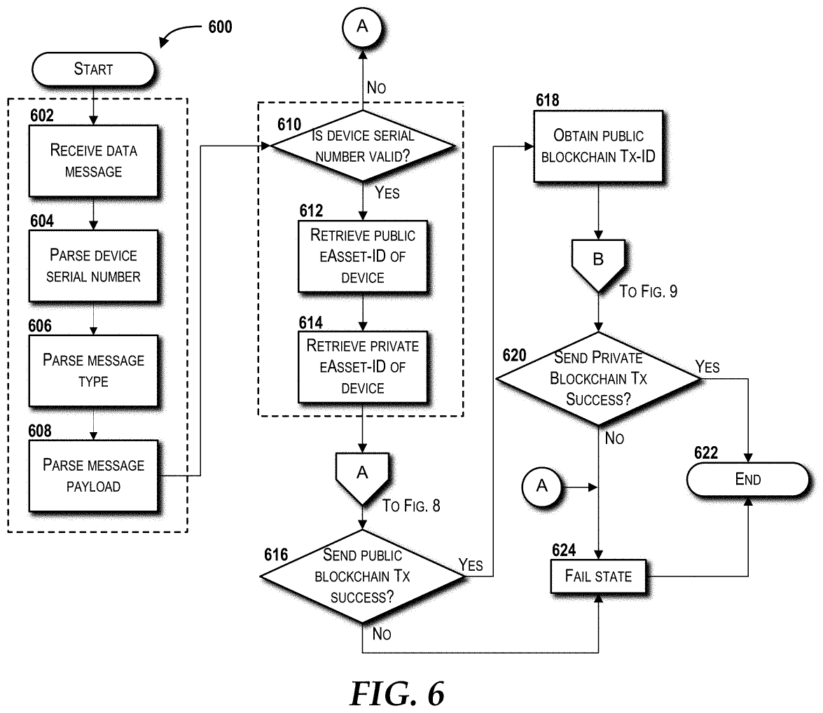

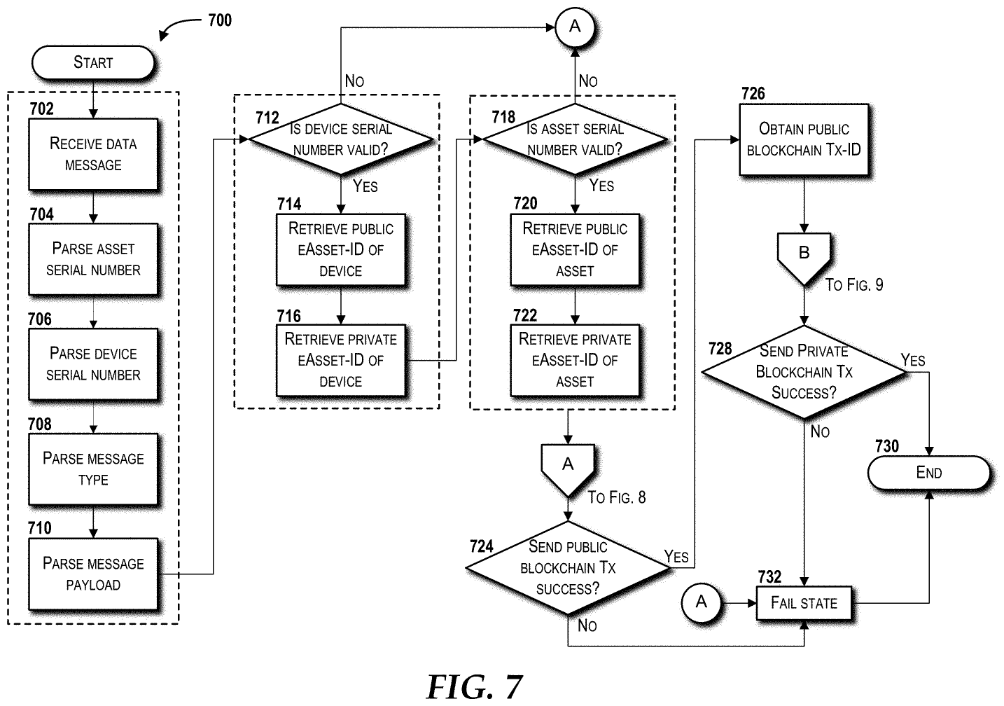

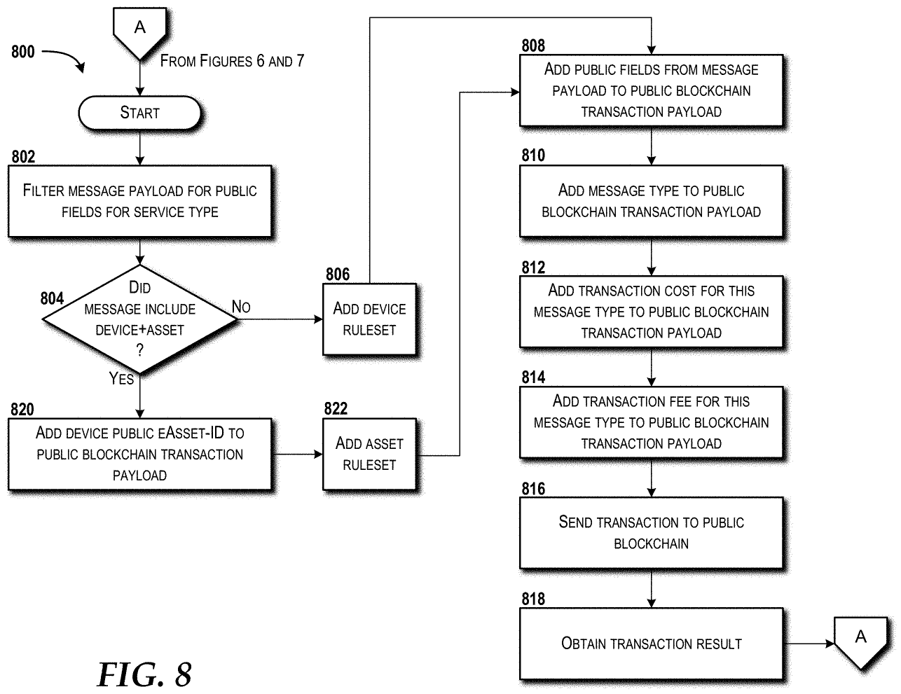

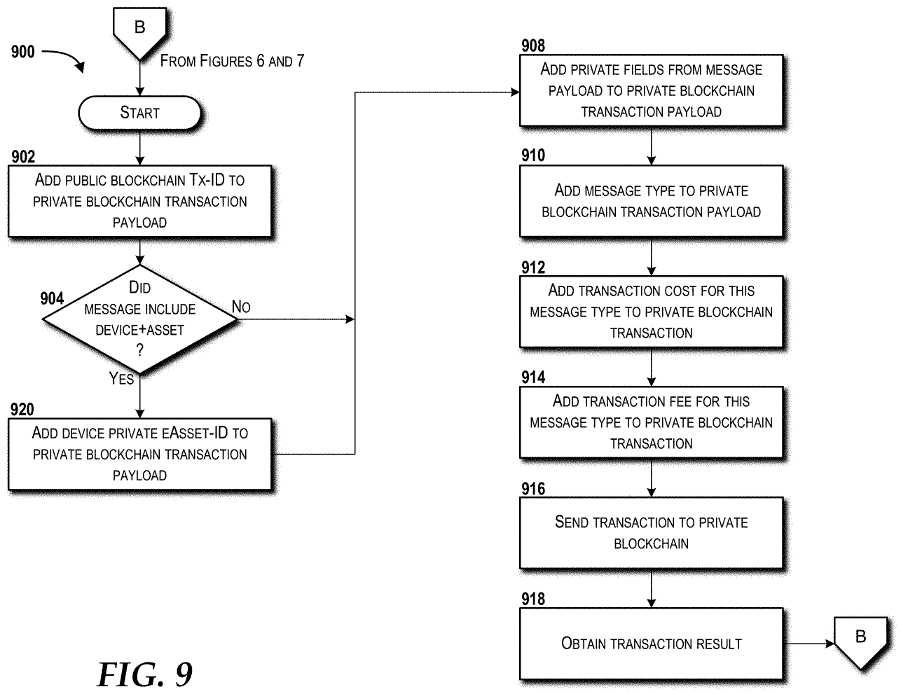

Turning now to FIG. 6, a method 300 for handling a data flow for a device-only message will be described, according to an illustrative embodiment. The method 600 begins and proceeds to operation 602. At operation 602, the device gateway 120 receives a message, such as the data message 104 (best shown in FIG. 1). From operation 602, the method 600 proceeds to operation 604. At operation 604, the device gateway 120 parses the device serial number from the data message 104 to identify the device that sent the data message, such as the data source device 102 (best shown in FIG. 1). From operation 604, the method 600 proceeds to operation 606. At operation 606, the device gateway 120 parses a message type (i.e., device-only or device+asset). From operation 606, the method 600 proceeds to operation 608. At operation 608, the device gateway 120 parses the message payload from the data message 104.

From operation 608, the method 600 proceeds to operation 610. At operation 610, the device gateway 120 determines if the device serial number is valid. If so, the method 600 proceeds to operation 612. At operation 612, the device gateway 120 retrieves the device public eAsset-ID 514. From operation 612, the method 600 proceeds to operation 614. At operation 614, the device gateway 120 retrieves the device private eAsset-ID 518.

From operation 614, the method 600 proceeds to operation 802 of the method 800 shown in FIG. 8. Output of the method 800 is a transaction result, which is returned by the method 800 to operation 616 of the method 600. At operation 616, the device gateway 120 determines whether the public blockchain transaction was successful. If so, the method 600 proceeds to operation 618. At operation 618, the device gateway 120 obtains the public blockchain transaction ID 510.

From operation 618, the method 600 proceeds to operation 902 of the method 900 shown in FIG. 9. Output of the method 900 is a transaction result, which is returned by the method 900 to operation 620 of the method 600. At operation 620, the device gateway 120 determines whether the private blockchain transaction was successful. If so, the method 600 proceeds to operation 622. The method 600 can end at operation 622. If, however, the device gateway 120 determines that the private blockchain transaction was not successful, the method 600 proceeds to operation 624. At operation 624, the transaction fails, and the method proceeds to operation 622, where the method 600 can end. Similarly, if, at operation 616 or operation 610, the device gateway 120 determines that the public blockchain transaction was not successful, the method 600 the method 600 proceeds to operation 624. At operation 624, the transaction fails, and the method proceeds to operation 622, where the method 600 can end.

Turning now to FIG. 7 a method 700 for handling a data flow for a device+asset message will be described, according to an illustrative embodiment. The method 700 begins and proceeds to operation 702. At operation 702, the device gateway 120 receives a message, such as the data message 104 (best shown in FIG. 1). From operation 702, the method 700 proceeds to operation 704. At operation 704, the device gateway 120 parses the asset serial number from the data message 104 to identify the asset associated with the device 102 that sent the data message 104. From operation 704, the method 700 proceeds to operation 706. At operation 706, the device gateway 120 parses the device serial number from the data message 104 to identify the device 102. From operation 706, the method 700 proceeds to operation 708. At operation 708, the device gateway 120 parses a message type. From operation 708, the method 700 proceeds to operation 710. At operation 710, the device gateway 120 parses the message payload from the message 104.

From operation 710, the method 700 proceeds to operation 712. At operation 712, the device gateway 120 determines if the device serial number is valid. If so, the method 700 proceeds to operation 714. At operation 714, the device gateway 120 retrieves the public eAsset-ID of the device 102. From operation 714, the method 700 proceeds to operation 716. At operation 716, the device gateway 120 retrieves the private eAsset-ID 518 of the device 102.

From operation 716, the method 700 proceeds to operation 718. At operation 718, the device gateway 120 determines if the asset serial number is valid. If so, the method 700 proceeds to operation 720. At operation 720, the device gateway 120 retrieves the public eAsset-ID of the device 102. From operation 720, the method 700 proceeds to operation 722. At operation 722, the device gateway 120 retrieves the private eAsset-ID 518 of the device 102.

From operation 722, the method 700 proceeds to operation 802 of the method 800 shown in FIG. 8. Output of the method 800 is a transaction result, which is returned by the method 800 to operation 724 of the method 600. At operation 724, the device gateway 120 determines whether the public blockchain transaction was successful. If so, the method 700 proceeds to operation 726. At operation 726, the device gateway 120 obtains the public blockchain transaction ID 510.

From operation 726, the method 700 proceeds to operation 902 of the method 900 shown in FIG. 9. Output of the method 900 is a transaction result, which is returned by the method 900 to operation 728 of the method 700. At operation 728, the device gateway 120 determines whether the private blockchain transaction was successful. If so, the method 700 proceeds to operation 730. The method 700 can end at operation 730. If, however, the device gateway 120 determines that the private blockchain transaction was not successful, the method 700 proceeds to operation 732. At operation 732, the transaction fails, and the method proceeds to operation 730, where the method 700 can end. Similarly, if, at operation 724, 712, or 718, the device gateway 120 determines that the public blockchain transaction was not successful, the method 700 the method 700 proceeds to operation 732. At operation 732, the transaction fails, and the method proceeds to operation 730, where the method 700 can end.

Turning now to FIG. 8, a flow diagram illustrating aspects of a method 800 for creating a public blockchain transaction and obtaining a public blockchain transaction result will be described, according to an illustrative embodiment. The method 800 will be described with reference to FIG. 8 and additional reference to FIGS. 1D, 5A, and 5B.

The method 800 begins and proceeds to operation 802. At operation 802, the device gateway 120 filters the message payload of the message 104 the public message fields 504 based upon the service type. From operation 802, the method 800 proceeds to operation 804. At operation 804, the device gateway 120 determines if the message type 506 indicates that the message 104 originated from a device+asset. If the device gateway 120 determines that the message type 506 does not indicate that the message 104 originated from a device+asset, the method 800 proceeds to operation 806. At operation 806, the device gateway 120 adds the device ruleset 508 to the public device-only blockchain transaction payload 500A.

From operation 806, the method 800 proceeds to operation 808. At operation 808, the device gateway 120 adds the public message fields 504 from the message payload to the public device-only blockchain transaction payload 500A. From operation 808, the method 800 proceeds to operation 810. At operation 810, the device gateway 120 adds the message type 506 to the public device-only blockchain transaction payload 500A. From operation 810, the method 800 proceeds to operation 812. At operation 812, the device gateway 120 adds the transaction cost for the message type to the public blockchain transaction. From operation 812, the method 800 proceeds to operation 814. At operation 814, the device gateway 120 adds the transaction fee for the message type to the public blockchain transaction. From operation 814, the method 800 proceeds to operation 816. At operation 816, the device gateway 120 sends the public blockchain transaction to the public blockchain transaction pool 130. From operation 816, the method 800 proceeds to operation 818. At operation 818, the device gateway 120 obtains a transaction result (i.e., successful or unsuccessful) and returns the result to FIG. 6 or FIG. 7 as the case may be.

Returning to operation 804, if the device gateway 120 determines that the message type 506 indicates that the message 104 originated from a device+asset, the method 800 proceeds to operation 820. At operation 820, the device gateway 120 adds the device public eAsset-ID 514 to the public device+asset blockchain transaction payload 502A. From operation 820, the method 800 proceeds to operation 822. At operation 822, the device gateway 120 adds the asset ruleset 516 to the device+asset public blockchain transaction payload 502A. From operation 822, the method 800 proceeds to operation 808. The method 800 then proceeds as described above, starting with operation 808.

Turning now to FIG. 9, a flow diagram illustrating aspects of a method 900 for creating a private blockchain transaction and obtaining a private blockchain transaction result will be described, according to an illustrative embodiment. The method 900 will be described with reference to FIG. 9 and additional reference to FIGS. 1D, 5A, and 5B.

The method 900 begins and proceeds to operation 902. At operation 902, the device gateway 120 adds the public blockchain transaction ID 510 to a private blockchain transaction payload. From operation 902, the method 900 proceeds to operation 904. At operation 904, the device gateway 120 determines if the message type 506 indicates that the message 104 originated from a device+asset. If the device gateway 120 determines that the message type 506 does not indicate that the message 104 originated from a device+asset, the method 900 proceeds to operation 908.

At operation 908, the device gateway 120 adds all message fields 512 (including any private fields) from the message payload to the private device-only blockchain transaction payload 500B. From operation 908, the method 900 proceeds to operation 910. At operation 910, the device gateway 120 adds the message type 506 to the private device-only blockchain transaction payload 500B. From operation 910, the method 900 proceeds to operation 912. At operation 912, the device gateway 120 adds the transaction cost for the message type 506 to the private blockchain transaction. From operation 912, the method 900 proceeds to operation 914. At operation 914, the device gateway 120 adds the transaction fee for the message type 506 to the private blockchain transaction. From operation 914, the method 900 proceeds to operation 916. At operation 916, the device gateway 120 sends the private blockchain transaction to the private transaction pool 130′. From operation 916, the method 900 proceeds to operation 918. At operation 918, the device gateway 120 obtains a transaction result (i.e., successful or unsuccessful) and returns the result to FIG. 6 or FIG. 7 as the case may be.

Returning to operation 904, if the device gateway 120 determines that the message type 506 indicates that the message 104 originated from a device+asset, the method 900 proceeds to operation 920. At operation 920, the device gateway 120 adds the device private eAsset-ID 518 to the private device+asset blockchain transaction payload 502B. From operation 920, the method 900 proceeds to operation 908. The method 900 then proceeds as described above, starting with operation 908.

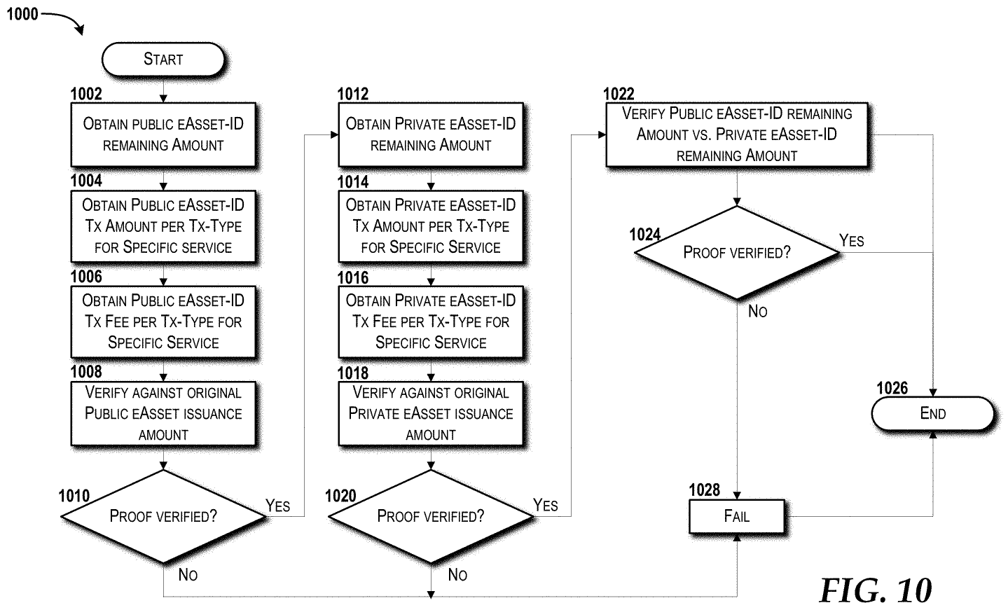

Turning now to FIG. 10, a flow diagram illustrating aspects of a method 1000 for verifying public versus private IoT transaction integrity of individual device or assets by a home enterprise edge gateway (e.g., the device gateway 120 or one of the third party gateways 124) will be described, according to an illustrative embodiment. The method 1000 begins when the home enterprise edge gateway receives a blockchain transaction from either the public blockchain transaction pool 130 or the private blockchain transaction pool 130′, and proceeds to operation 1002. If a private blockchain transaction was received, the home enterprise edge gateway can retrieve the corresponding public eAsset-ID from the private eAsset-ID of the private blockchain transaction. At operation 1002, the home enterprise edge gateway obtains the remaining amount associated with the public eAsset-ID. The original amount is allocated at operation 328 in FIGS. 3A-3C). From operation 1002, the method 1000 proceeds to operation 1004. At operation 1004, the home enterprise edge gateway obtains the transaction cost, per transaction type for specific service, associated with the public eAsset-ID (provisioned at operation 330 in FIGS. 3A-3C). From operation 1004, the method 1000 proceeds to operation 1006. At operation 1006, the home enterprise edge gateway obtains the transaction fee, per transaction type for specific service, associated with the public eAsset-ID (provisioned at operation 332 in FIGS. 3A-3C).

From operation 1006, the method 1000 proceeds to operation 1008. At operation 1008, the home enterprise edge gateway verifies the remaining amount (obtained at operation 1002) against the original amount (allocated at operation 328 in FIGS. 3A-3C). From operation 1008, the method 1000 proceeds to operation 1010. At operation 1010, the home enterprise gateway determines whether the proof is verified. If so, the method 1000 proceeds to operation 1012.

At operation 1012, the home enterprise edge gateway obtains the remaining amount associated with the private eAsset-ID. The original amount is allocated at operation 326 in FIGS. 3A-3C). From operation 1012, the method 1000 proceeds to operation 1014. At operation 1014, the home enterprise edge gateway obtains the transaction cost, per transaction type for specific service, associated with the private eAsset-ID (provisioned at operation 334 in FIGS. 3A-3C). From operation 1014, the method 1000 proceeds to operation 1016. At operation 1016, the home enterprise edge gateway obtains the transaction fee, per transaction type for specific service, associated with the private eAsset-ID (provisioned at operation 332 in FIGS. 3A-3C).

From operation 1016, the method 1000 proceeds to operation 1018. At operation 1018, the home enterprise edge gateway verifies the remaining amount (obtained at operation 1012) against the original amount (allocated at operation 326 in FIGS. 3A-3C). From operation 1018, the method 1000 proceeds to operation 1020. At operation 1020, the home enterprise edge gateway determines whether the proof is verified. If so, the method 1000 proceeds to operation 1022.

At operation 1022, the home enterprise gateway verifies the remaining amount associated with the public eAsset-ID (obtained at operation 1002) against the remaining amount associated with the private eAsset-ID (obtained at operation 1012). From operation 1022, the method 1000 proceeds to operation 1024. At operation 1024, the home enterprise gateway determines whether the proof is verified. If so, the method 1000 proceeds to operation 1026. The method 1000 can end at operation 1026.

Returning to operation 1010, 1020, or 1024, if the proof cannot be verified, the method 1000 proceeds to operation 1028. At operation 1028, the verification fails. From operation 1028, the method 1000 proceeds to operation 1026. The method 1000 can end at operation 1026.

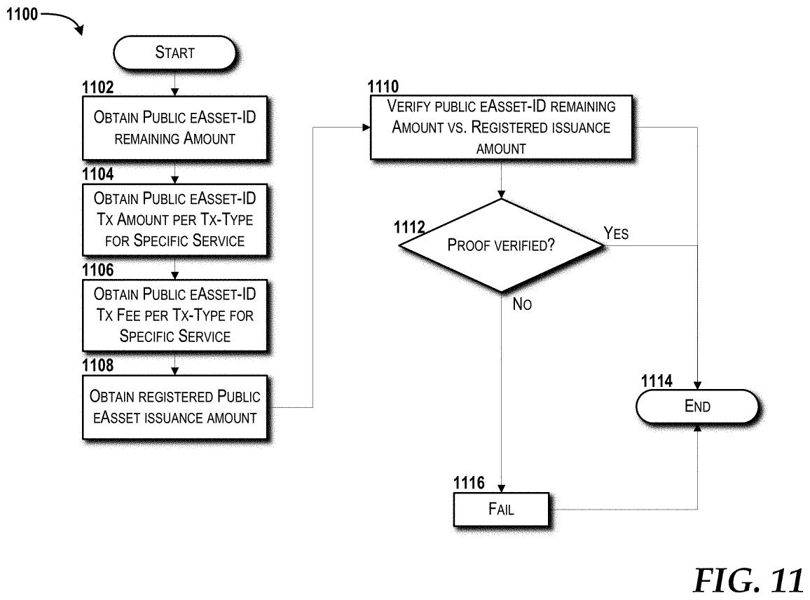

Turning now to FIG. 11, a method 1100 for verifying public individual device or asset IoT transaction integrity by a participating enterprise edge gateway will be described, according to an illustrative embodiment. The method 1100 begins when any participating enterprise edge gateway receives a blockchain transaction from the public blockchain transaction pool 130, and proceeds to operation 1102. At operation 1102, the participating enterprise edge gateway (e.g., the visited device gateway 120B or one of the visited third party gateways 124A-124N) obtains the remaining amount associated with the device public eAsset-ID 514. The original amount is allocated at operation 328 in FIGS. 3A-3C. From operation 1102, the method 1100 proceeds to operation 1104. At operation 1104, the participating enterprise edge gateway obtains the transaction cost, per transaction type for specific service, associated with the device public eAsset-ID 514 (provisioned at operation 330 in FIGS. 3A-3C). From operation 1104, the method 1100 proceeds to operation 1106. At operation 1106, the participating enterprise edge gateway obtains the transaction fee, per transaction type for specific service, associated with the public eAsset-ID (provisioned at operation 332 in FIGS. 3A-3C).

From operation 1106, the method 1100 proceeds to operation 1108. At operation 1108, the participating enterprise gateway obtains the issuance amount of the registered public eAsset-ID. From operation 1108, the method 1100 proceeds to operation 1110. At operation 1110, the participating enterprise gateway verifies the remaining amount (obtained at operation 1102) against the registered issuance amount (obtained at operation 1108). From operation 1110, the method 1000 proceeds to operation 1112. At operation 1112, the participating enterprise gateway determines whether the proof is verified. If so, the method 1100 proceeds to operation 1114. The method 1100 can end at operation 1114.

Returning to operation 1112, if the participating enterprise gateway determines that the proof is not verified, the method 1100 proceeds to operation 1116. At operation 1116, the verification fails. From operation 1116, the method 1100 proceeds to operation 1114. The method 1100 can end at operation 1114.

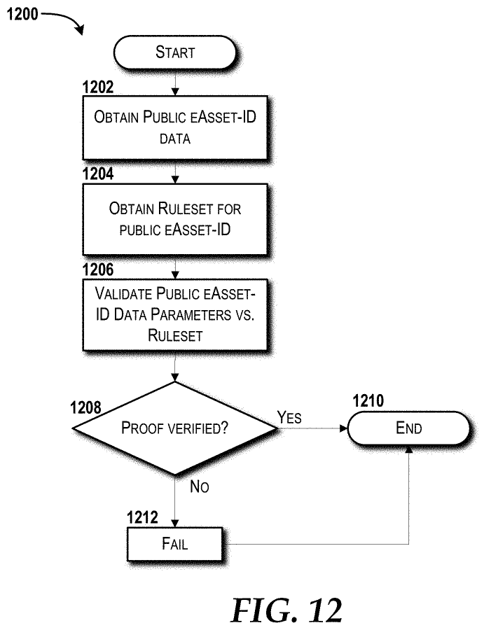

Turning now to FIG. 12, a flow diagram illustrating aspects of a method 1200 for ruleset verification of public device or asset data by any participating enterprise edge gateway will be described, according to an illustrative embodiment. The method 1200 begins when any participating enterprise edge gateway receives a blockchain transaction from the blockchain transaction pool 130, and proceeds to operation 1202. At operation 1202, the gateway obtains the public eAsset-ID data. From operation 1202, the method 1200 proceeds to operation 1204. At operation 1204, the gateway obtains the ruleset for the public eAsset-ID. From operation 1204, the method 1200 proceeds to operation 1206. At operation 1206, the gateway validates the public eAsset-ID data parameters versus the ruleset. From operation 1206, the method 1200 proceeds to operation 1208. At operation 1208, the gateway determines if proof has been verified. If so, the method 1200 proceeds to operation 1210, where the method 1200 ends. If, however, the gateway determines that proof has not been verified, the method 1200 proceeds to operation 1212, where the verification fails. The method 1200 then proceeds to operation 1210, where the method 1200 can end.

Turning now to FIG. 13, a block diagram illustrating aspects of a combination data source device 1300 (i.e., device+asset) that combines an asset 1302 and an IoT device 1304 will be described, according to an illustrative embodiment. The asset 1302 can be any “thing” that is to be tracked and/or monitored. The asset 1302 is flexible and can support n-number of sensor combinations to monitor one or more parameters associated with the asset 1302. The asset 1302 is in communication with the programmable IoT device 1304 via an asset-to-device bus 1306. The embodiments described herein focus on a single device 1304. The IoT device 1304 is flexible and can support n-number of sensor combinations to monitor one or more parameters associated with the asset 1302. The parameter(s) to be monitored can be any parameter of the asset 1302 and/or the IoT device 1304 that is/are capable of being monitored by one or more sensors. The sensors can be off-the-shelf sensors or custom sensors built to monitor a specific one or more parameters associated with the asset 1302. As such, the concepts and technologies disclosed herein are not limited to any particular set of parameters to be monitored. By way of example, however, the parameters can be environmental parameters such as temperature or humidity of the asset 1302; security parameters such as when a door open/close events; or geographical/location parameters such as latitude and longitude coordinates.

The asset-to-device bus 1306 can enable bi-directional communication between the asset 1302 and the IoT device 1304. More particularly, the device 1304 can communicate with a sensor hub 1308 of the asset 1302 to obtain sensor data from any number of asset sensors 1310A-1310N (hereinafter referred to individually as “asset sensor 1310”, or collectively as “asset sensors 1310”). The asset sensors 1310 can be associated with the asset 1302 (e.g., installed, attached, or otherwise implemented) so as to monitor different aspects of the asset 1302. The asset sensor(s) 1310, in some embodiments, is/are associated with the asset 1302 as the asset 1302 moves through a supply chain, such as, for example, from manufacturing (or harvesting, mining, or other method of creation or procurement) to warehousing to fleet/shipping and finally to retail or another link in the supply chain. The supply chain may be populated by the various owners of the data collected by the asset 1302 and/or the device 1304 to be sent in the data message 104. In this manner, the asset sensors 1310 can include sensors that monitor/track data that is common among the different verticals in the supply chain. For example, the asset sensors 1310 may include a temperature sensor and/or humidity sensor configured to measure the temperature and/or humidity of the asset 1302 itself or an environment in which the asset 1302 is located.

The asset-to-device bus 1306 can be or can include any interface over which data can be shared between the sensor hub 1308 and the device 1304. The asset-to-device bus 1306, in some embodiments, also can provide power to the sensor hub 1308 in sufficient capacity to enable operation of the asset sensors 1310. Although a power supply is not illustrated, AC and DC power supplies are contemplated, including mains and battery-based implementations. The asset-to-device bus 1306 can be implemented as a wired, wireless, or combined wired/wireless interface. The asset-to-device bus 1306 can utilize any standardized interface such as, but no limited to, serial bus, universal serial bus (“USB”), serial ATA (“SATA”), eSATA, BLUETOOTH, IEEE 1394 (“FIREWIRE”), serial peripheral interface (“SPI”), inter-integrated circuit (“I2C”), WIFI, combinations thereof, and the like. The asset-to-device bus 1306 alternatively can utilize a proprietary interface.

The asset-to-device bus 1306 can be an extension of a device bus 1312 associated with the device 1304. The device bus 1312 can enable communication between components of the device 1304, including a controller 1314, a network module 1316, and any number of device sensors 1318A-1318N (hereinafter referred to individually as “device sensor 1318”, or collectively as “device sensors 1318”), and with the sensor hub 1308 that terminates the asset-to-device bus 1306. This allows sensors external to the device 1304, such as the asset sensors 1310 connected to the sensor hub 1308, to be viewed by the device 1304, and more specifically, the controller 1314 of the device 1304, as internal sensors similar to the device sensors 1318. In this manner, the device 1304 can provide additional monitoring/tracking functionality to the asset 1302. Moreover, as noted above, the asset sensors 1310 can be powered by the device 1304 similar to the device sensors 1318 and other components of the device 1304.

The sensor hub 1308 is extensible so that n-number of sensors can be attached externally to the device 1304. The sensor hub 1308 can be associated with an electronic identifier (shown as “asset ID 1320”). The asset ID 1320 is a unique identifier to uniquely identify the asset 1302 among a plurality of other assets (not shown). The format of the asset ID 1320 can include any combination of letters, numbers, symbols, and/or other characters. The asset ID 1320 can be or can include a serial number (or other identifier) associated with the asset 1302. The asset ID 1320 can be in a standardized format or a proprietary format.

The asset sensors 1310 and the device sensors 1318 can be any sensor types. By way of example, and not limitation, the asset sensors 1310 and the device sensors 1318 can be or can include acceleration sensors, acoustic sensors, advanced sensors, alkalinity sensors, ambient sensors, angle sensors, auditory sensors, automation sensors, automotive sensors, barometric sensors, bio sensors, chemical sensors, control sensors, density sensors, depth sensors, directional sensors, displacement sensors, distance sensors, door sensors, electric current sensors, electric potential sensors, flow sensors, fluid sensors, fluid velocity sensors, force sensors, gas sensors, glass sensors, global positioning system (“GPS”) sensors, heat sensors, humidity sensors, imaging sensors, industrial sensors, infrared sensors, interface sensors, ionizing sensors, laser sensors, level sensors, light sensors, liquid sensors, magnetic sensors, manufacturing sensors, navigation sensors, optical sensors, pH Sensors, photon sensors, polar sensors, position sensors, pressure sensors, proximity sensors, radar sensors, radiation sensors, radio sensors, shock sensors, smoke sensors, sound sensors, speed sensors, temperature sensors, thermal sensors, ultrasonic sensors, velocity sensors, vibration sensors, yaw sensors, any combinations thereof, and the like. Some examples disclosed herein focus on sensor types such as temperature and humidity sensors. It should be understood that these examples are merely exemplary and should not be construed as being limiting in any way.

The controller 1314 can control at least some of the functions of the device 1304. The controller 1314 can include one or more processors, which can be operatively linked and in communication with one or more memory components. The processor(s) can execute computer-executable instructions stored in the memory component(s). Execution of the computer-executable instructions can cause the controller 1314 to perform various functions described herein. In some embodiments, the controller 1314 is designed as an integrated circuit, such as a microcontroller, system-on-a-chip, or the like, that includes the processor(s), memory component(s), and input/output components (e.g., the asset-to-device bus 1306 and/or the device bus 1312). In some embodiments, the network module 1316 can be implemented as part of the controller 1314. Those skilled in the art will appreciate the numerous designs suitable for the device 1304 to effectively provide the functionality described herein. Although components of the device 1304 are shown separately in the illustrated embodiment, integration of two or more of these components is contemplated and may be beneficial for some implementations. As such, the illustrated example and other examples described herein for the design of the device 1304 should not be construed as being limiting in any way.

The device 1304 can be associated with a device ID 1322. The device ID 1322 can be a device serial number or other identifier that uniquely identifies the device 1304. In the illustrated example, the device ID 1322 is shown as being stored in the controller 1314 (e.g., in a memory component thereof). The device ID 1322 may be stored elsewhere such as, for example, a dedicated memory component that may provide additional security to avoid spoofing or other tampering with the device 1304.

The network module 1316 can be operatively linked and in communication with one or more communications networks (best shown in FIG. 8). The network module 1316 can be or can include a wireless network interface. The network module 1316 can be used to communicate with other devices and/or networks (not shown). In some embodiments, the network module 1316 includes or is otherwise in communication with a subscriber identity module (“SIM”) system (not shown). The SIM system can include a universal SIM (“USIM”), a universal integrated circuit card (“UICC”), and/or other identity devices that can be uniquely identified by a SIM ICCID 1324. The SIM system can include and/or can be connected to or inserted into an interface such as a slot interface. In some embodiments, the interface can be configured to accept insertion of other identity cards or modules for accessing various types of networks. Additionally, or alternatively, the interface can be configured to accept multiple subscriber identity cards. The network module 1316 can be associated with its own unique identifier shown as a network module ID 1326. Because other devices and/or modules for identifying users, owners, and/or the device 1304 are contemplated, it should be understood that these embodiments are illustrative, and should not be construed as being limiting in any way.

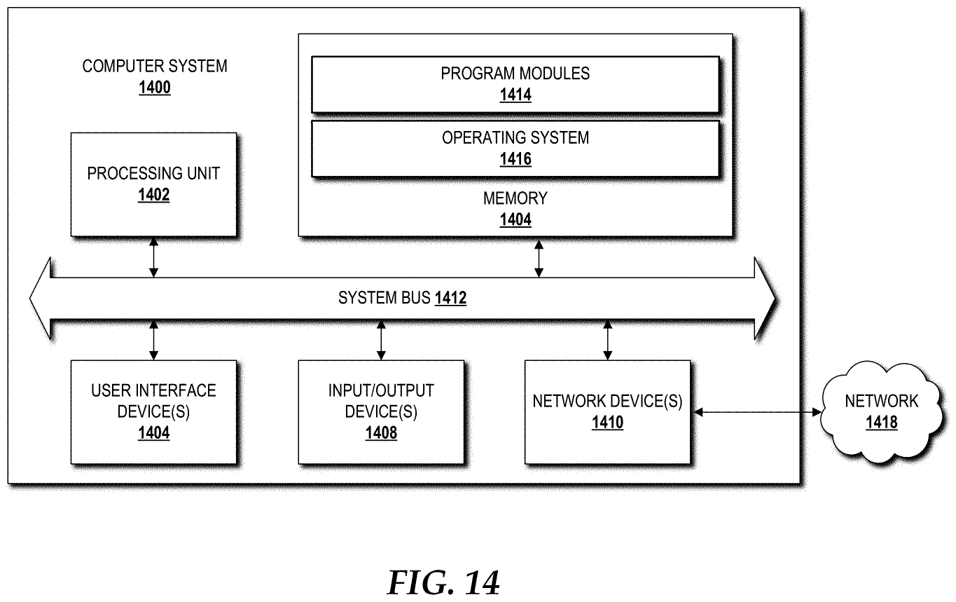

Turning now to FIG. 14, a block diagram illustrating a computer system 1400 configured to provide the functionality described herein in accordance with various embodiments of the concepts and technologies disclosed herein. In some embodiments, the data source device 102, the network gateway 116, the device gateway 120, the party₁ gateway 124A, and/or the party₁ gateway 124N can be configured like and/or can have an architecture similar or identical to the computer system 1400 described herein with respect to FIG. 14. It should be understood, however, that any of these systems, devices, or elements may or may not include the functionality described herein with reference to FIG. 14.

The computer system 1400 includes a processing unit 1402, a memory 1404, one or more user interface devices 1406, one or more input/output (“I/O”) devices 1408, and one or more network devices 1410, each of which is operatively connected to a system bus 1412. The bus 1412 enables bi-directional communication between the processing unit 1402, the memory 1404, the user interface devices 1406, the I/O devices 1408, and the network devices 1410.

The processing unit 1402 may be a standard central processor that performs arithmetic and logical operations, a more specific purpose programmable logic controller (“PLC”), a programmable gate array, or other type of processor known to those skilled in the art and suitable for controlling the operation of the computer system 1400.

The memory 1404 communicates with the processing unit 1402 via the system bus 1412. In some embodiments, the memory 1404 is operatively connected to a memory controller (not shown) that enables communication with the processing unit 1402 via the system bus 1412. The memory 1404 includes an operating system 1414 and one or more program modules 1416. The operating system 1414 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 1416 may include various software and/or program modules described herein. By way of example, and not limitation, computer-readable media may include any available computer storage media or communication media that can be accessed by the computer system 1400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 1400. In the claims, the phrase “computer storage medium,” “computer-readable storage medium,” and variations thereof does not include waves or signals per se and/or communication media, and therefore should be construed as being directed to “non-transitory” media only.

The user interface devices 1406 may include one or more devices with which a user accesses the computer system 1400. The user interface devices 1406 may include, but are not limited to, computers, servers, personal digital assistants, cellular phones, or any suitable computing devices. The I/O devices 1408 enable a user to interface with the program modules 1416. In one embodiment, the I/O devices 1408 are operatively connected to an I/O controller (not shown) that enables communication with the processing unit 1402 via the system bus 1412. The I/O devices 1408 may include one or more input devices, such as, but not limited to, a keyboard, a mouse, or an electronic stylus. Further, the I/O devices 1408 may include one or more output devices, such as, but not limited to, a display screen or a printer to output data.

The network devices 1410 enable the computer system 1400 to communicate with other networks or remote systems via one or more networks, such as a network 1418. Examples of the network devices 1410 include, but are not limited to, a modem, a RF or infrared (“IR”) transceiver, a telephonic interface, a bridge, a router, or a network card. The network(s) may include a wireless network such as, but not limited to, a WLAN such as a WI-FI network, a WWAN, a Wireless Personal Area Network (“WPAN”) such as BLUETOOTH, a WMAN such a WiMAX network, or a cellular network. Alternatively, the network(s) may be a wired network such as, but not limited to, a WAN such as the Internet, a LAN, a wired PAN, or a wired MAN.

Turning now to FIG. 15, a network 1500 is illustrated, according to an illustrative embodiment. Communications among the data source device 102, the network gateway 116, the device gateway 120, the party₁ gateway 124A, and the partyₙ gateway 124N can be handled over the network 1500, and in particular, a cellular network 1502 (e.g., mobile network), a packet data network 1504, for example, the Internet, and a circuit switched network 1506, for example, a publicly switched telephone network (“PSTN”). The cellular network 1502 includes various components such as, but not limited to, base transceiver stations (“BT Ss”), Node-B's, e-Node-B's, g-Node-B's base station controllers (“B SCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 1502 also includes radios and nodes for receiving and transmitting voice, data, and combinations thereof to and from radio transceivers, networks, the packet data network 1504, and the circuit switched network 1506.

A mobile communications device 1506, such as, for example, the data source device 102, the network gateway 116, the device gateway 120, the party₁ gateway 124A, and/or the partyₙ gateway 124N, a cellular telephone, a user equipment, a mobile terminal, a PDA, a laptop computer, a handheld computer, and combinations thereof, can be operatively connected to the cellular network 1502. The mobile communications device 1506 can be operatively connected to the cellular network 1502. The cellular network 1502 can be configured as a 2G GSM network and can provide data communications via GPRS and/or EDGE. Additionally, or alternatively, the cellular network 1502 can be configured as a 3G UMTS network and can provide data communications via the HSPA protocol family, for example, HSDPA, EUL (also referred to as HSDPA), and HSPA+. The cellular network 1502 also is compatible with 4G mobile communications standards as well as evolved and future mobile standards.

The packet data network 1504 includes various devices, for example, the data source device 102, the network gateway 116, the device gateway 120, the party₁ gateway 124A, and/or the partyₙ gateway 124N, servers, computers, databases (e.g., the network database 1115, the device database 122, the party₁ database 126A, and/or the partyₙ database 126N), and other devices in communication with another, as is generally known. The packet data network 1504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 1504 includes or is in communication with the Internet.

The circuit switched network 1506 includes various hardware and software for providing circuit switched communications. The circuit switched network 1506 may include, or may be, what is often referred to as a plain old telephone system (“POTS”). The functionality of a circuit switched network 1506 or other circuit-switched network are generally known and will not be described herein in detail.

The illustrated cellular network 1502 is shown in communication with the packet data network 1504 and a circuit switched network 1506, though it should be appreciated that this is not necessarily the case. One or more Internet-capable devices 1510, for example, the data source device 102, the network gateway 116, the device gateway 120, the party₁ gateway 124A, and/or the partyₙ gateway 124N, a personal computer (“PC”), a laptop, a portable device, or another suitable device, can communicate with one or more cellular networks 1502, and devices connected thereto, through the packet data network 1504. It also should be appreciated that the Internet-capable device 1510 can communicate with the packet data network 1504 through the circuit switched network 1506, the cellular network 1502, and/or via other networks (not illustrated).

As illustrated, a communications device 1512, for example, a telephone, facsimile machine, modem, computer, or the like, can be in communication with the circuit switched network 1506, and therethrough to the packet data network 1504 and/or the cellular network 1502. It should be appreciated that the communications device 1512 can be an Internet-capable device, and can be substantially similar to the Internet-capable device 1510.

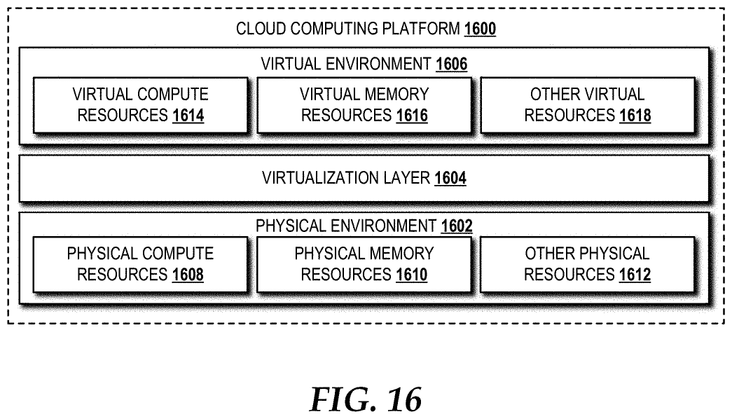

Turning now to FIG. 16, an illustrative cloud computing platform 1600 will be described, according to an illustrative embodiment. The data source device 102, the network gateway 116, the device gateway 120, the party₁ gateway 124A, and/or the partyₙ gateway 124N, and/or other networks, systems, and/or devices disclosed herein can be implemented and/or controlled, at least in part, in/by the cloud computing platform 1600.

The cloud computing platform 1600 includes a physical environment 1602, a virtualization layer 1604, and a virtual environment 1606. While no connections are shown in FIG. 16, it should be understood that some, none, or all of the components illustrated in FIG. 16 can be configured to interact with one other to carry out various functions described herein. In some embodiments, the components are arranged so as to communicate via one or more networks. Thus, it should be understood that FIG. 16 and the remaining description are intended to provide a general understanding of a suitable environment in which various aspects of the embodiments described herein can be implemented, and should not be construed as being limiting in any way.

The physical environment 1602 provides hardware resources that, in the illustrated embodiment, include one or more physical compute resources 1608, one or more physical memory resources 1610, and one or more other physical resources 1612.

The physical compute resource(s) 1608 can include one or more hardware components that perform computations to process data and/or to execute computer-executable instructions of one or more application programs, one or more operating systems, and/or other software. The physical compute resources 1608 can include one or more central processing units (“CPUs”) configured with one or more processing cores. The physical compute resources 1608 can include one or more graphics processing unit (“GPU”) configured to accelerate operations performed by one or more CPUs, and/or to perform computations to process data, and/or to execute computer-executable instructions of one or more application programs, one or more operating systems, and/or other software that may or may not include instructions particular to graphics computations. In some embodiments, the physical compute resources 1608 can include one or more discrete GPUs. In some other embodiments, the physical compute resources 1608 can include CPU and GPU components that are configured in accordance with a co-processing CPU/GPU computing model, wherein the sequential part of an application executes on the CPU and the computationally-intensive part is accelerated by the GPU processing capabilities. The physical compute resources 1608 can include one or more system-on-chip (“SoC”) components along with one or more other components, including, for example, one or more of the physical memory resources 1610, and/or one or more of the other physical resources 1612. In some embodiments, the physical compute resources 1608 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The physical compute resources 1608 can be or can include one or more hardware components architected in accordance with an ARM architecture, available for license from ARM HOLDINGS of Cambridge, United Kingdom. Alternatively, the physical compute resources 1608 can be or can include one or more hardware components architected in accordance with an x86 architecture, such an architecture available from INTEL CORPORATION of Mountain View, Calif., and others. Those skilled in the art will appreciate the implementation of the physical compute resources 1608 can utilize various computation architectures, and as such, the physical compute resources 1608 should not be construed as being limited to any particular computation architecture or combination of computation architectures, including those explicitly disclosed herein.

The physical memory resource(s) 1610 can include one or more hardware components that perform storage/memory operations, including temporary or permanent storage operations. In some embodiments, the physical memory resource(s) 1610 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the physical compute resources 1608.

The other physical resource(s) 1612 can include any other hardware resources that can be utilized by the physical compute resources(s) 1608 and/or the physical memory resource(s) 1610 to perform operations described herein. The other physical resource(s) 1612 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The physical resources operating within the physical environment 1602 can be virtualized by one or more virtual machine monitors (not shown; also known as “hypervisors”) operating within the virtualization/control layer 1604 to create virtual resources that reside in the virtual environment 1606. The virtual machine monitors can be or can include software, firmware, and/or hardware that alone or in combination with other software, firmware, and/or hardware, creates and manages virtual resources operating within the virtual environment 1606.

The virtual resources operating within the virtual environment 1606 can include abstractions of at least a portion of the physical compute resources 1608, the physical memory resources 1610, and/or the other physical resources 1612, or any combination thereof, shown as virtual compute resources 1614, virtual memory resources 1616, and other virtual resources 1618, respectively. In some embodiments, the abstractions can include one or more virtual machines upon which one or more applications can be executed.

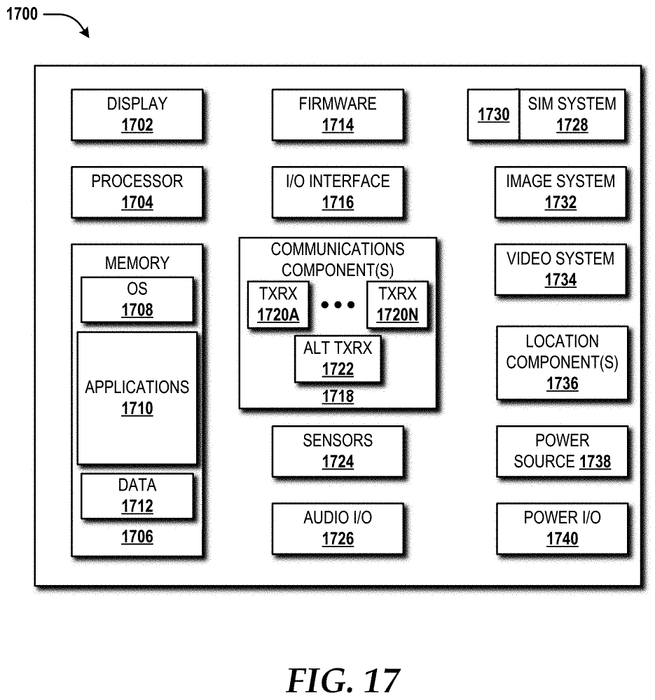

Turning now to FIG. 17, an illustrative mobile device 1700 and components thereof will be described. In some embodiments, the data source device 172, the network gateway 116, the device gateway 120, the party₁ gateway 124A, and/or the partyₙ gateway 124N described above can be configured as and/or can have an architecture similar or identical to the mobile device 1700 described herein in FIG. 17. While connections are not shown between the various components illustrated in FIG. 17, it should be understood that some, none, or all of the components illustrated in FIG. 17 can be configured to interact with one another to carry out various device functions. In some embodiments, the components are arranged so as to communicate via one or more busses (not shown). Thus, it should be understood that FIG. 17 and the following description are intended to provide a general understanding of a suitable environment in which various aspects of embodiments can be implemented, and should not be construed as being limiting in any way.

As illustrated in FIG. 17, the mobile device 1700 can include a display 1702 for displaying data. According to various embodiments, the display 1702 can be configured to display data described herein, network connection information, various GUI elements, text, images, video, virtual keypads and/or keyboards, messaging data, notification messages, metadata, Internet content, device status, time, date, calendar data, device preferences, map and location data, combinations thereof, and/or the like. The mobile device 1700 also can include a processor 1704 and a memory or other data storage device (“memory”) 1706. The processor 1704 can be configured to process data and/or can execute computer-executable instructions stored in the memory 1706. The computer-executable instructions executed by the processor 1704 can include, for example, an operating system 1708, one or more applications 1710, other computer-executable instructions stored in the memory 1706, or the like. In some embodiments, the applications 1710 also can include a UI application (not illustrated in FIG. 17).

The UI application can interface with the operating system 1708 to facilitate user interaction with functionality and/or data stored at the mobile device 1700 and/or stored elsewhere. In some embodiments, the operating system 1708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 1704 to aid a user in data communications, entering/deleting data, entering and setting user IDs and passwords for device access, configuring settings, manipulating content and/or settings, multimode interaction, interacting with other applications 1710, and otherwise facilitating user interaction with the operating system 1708, the applications 1710, and/or other types or instances of data 1712 that can be stored at the mobile device 1700.

The applications 1717, the data 1712, and/or portions thereof can be stored in the memory 1706 and/or in a firmware 1714, and can be executed by the processor 1704. The firmware 1714 also can store code for execution during device power up and power down operations. It can be appreciated that the firmware 1714 can be stored in a volatile or non-volatile data storage device including, but not limited to, the memory 1706 and/or a portion thereof.

The mobile device 1700 also can include an input/output (“I/O”) interface 1716. The I/O interface 1716 can be configured to support the input/output of data such as location information, presence status information, user IDs, passwords, and application initiation (start-up) requests. In some embodiments, the I/O interface 1716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 1700 can be configured to synchronize with another device to transfer content to and/or from the mobile device 1700. In some embodiments, the mobile device 1700 can be configured to receive updates to one or more of the applications 1710 via the I/O interface 1716, though this is not necessarily the case. In some embodiments, the I/O interface 1716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 1716 may be used for communications between the mobile device 1700 and a network device or local device.

The mobile device 1700 also can include a communications component 1718. The communications component 1718 can be configured to interface with the processor 1704 to facilitate wired and/or wireless communications with one or more networks. In some embodiments, the communications component 1718 includes a multimode communications subsystem for facilitating communications via the cellular network and one or more other networks.

The communications component 1718, in some embodiments, includes one or more transceivers. The one or more transceivers, if included, can be configured to communicate over the same and/or different wireless technology standards with respect to one another. For example, in some embodiments, one or more of the transceivers of the communications component 1718 may be configured to communicate using GSM, CDMAONE, CDMA2000, LTE, and various other 2G, 2.5G, 3G, 4G, 4.5G, 5G, and greater generation technology standards. Moreover, the communications component 1718 may facilitate communications over various channel access methods (which may or may not be used by the aforementioned standards) including, but not limited to, TDMA, FDMA, W-CDMA, OFDM, SDMA, and the like.

In addition, the communications component 1718 may facilitate data communications using GPRS, EDGE, the HSPA protocol family including HSDPA, EUL or otherwise termed HSUPA, HSPA+, and various other current and future wireless data access standards. In the illustrated embodiment, the communications component 1718 can include a first transceiver (“TxRx”) 1720A that can operate in a first communications mode (e.g., GSM). The communications component 1718 also can include an Nth transceiver (“TxRx”) 1720N that can operate in a second communications mode relative to the first transceiver 1720A (e.g., UMTS). While two transceivers 1720A-1720N (hereinafter collectively and/or generically referred to as “transceivers 1720”) are shown in FIG. 17, it should be appreciated that less than two, two, and/or more than two transceivers 1720 can be included in the communications component 1718.

The communications component 1718 also can include an alternative transceiver (“Alt TxRx”) 1722 for supporting other types and/or standards of communications. According to various contemplated embodiments, the alternative transceiver 1722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 1718 also can facilitate reception from terrestrial radio networks, digital satellite radio networks, internet-based radio service networks, combinations thereof, and the like. The communications component 1718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 1700 also can include one or more sensors 1724. The sensors 1724 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 1700 may be provided by an audio I/O component 1726. The audio I/O component 1726 of the mobile device 1700 can include one or more speakers for the output of audio signals, one or more microphones for the collection and/or input of audio signals, and/or other audio input and/or output devices.

The illustrated mobile device 1700 also can include a subscriber identity module (“SIM”) system 1728. The SIM system 1728 can include a universal SIM (“USIM”), a universal integrated circuit card (“UICC”) and/or other identity devices. The SIM system 1728 can include and/or can be connected to or inserted into an interface such as a slot interface 1730. In some embodiments, the slot interface 1730 can be configured to accept insertion of other identity cards or modules for accessing various types of networks. Additionally, or alternatively, the slot interface 1730 can be configured to accept multiple subscriber identity cards. Because other devices and/or modules for identifying users and/or the mobile device 1700 are contemplated, it should be understood that these embodiments are illustrative, and should not be construed as being limiting in any way.

The mobile device 1700 also can include an image capture and processing system 1732 (“image system”). The image system 1732 can be configured to capture or otherwise obtain photos, videos, and/or other visual information. As such, the image system 1732 can include cameras, lenses, charge-coupled devices (“CCDs”), combinations thereof, or the like. The mobile device 1700 may also include a video system 1734. The video system 1734 can be configured to capture, process, record, modify, and/or store video content. Photos and videos obtained using the image system 1732 and the video system 1734, respectively, may be added as message content to an MMS message, email message, and sent to another device. The video and/or photo content also can be shared with other devices via various types of data transfers via wired and/or wireless communication devices as described herein.

The mobile device 1700 also can include one or more location components 1736. The location components 1736 can be configured to send and/or receive signals to determine a geographic location of the mobile device 1700. According to various embodiments, the location components 1736 can send and/or receive signals from global positioning system (“GPS”) devices, assisted-GPS (“A-GPS”) devices, WI-FI/WIMAX and/or cellular network triangulation data, combinations thereof, and the like. The location component 1736 also can be configured to communicate with the communications component 1718 to retrieve triangulation data for determining a location of the mobile device 1700. In some embodiments, the location component 1736 can interface with cellular network nodes, telephone lines, satellites, location transmitters and/or beacons, wireless network transmitters and receivers, combinations thereof, and the like. In some embodiments, the location component 1736 can include and/or can communicate with one or more of the sensors 1724 such as a compass, an accelerometer, and/or a gyroscope to determine the orientation of the mobile device 1700. Using the location component 1736, the mobile device 1700 can generate and/or receive data to identify its geographic location, or to transmit data used by other devices to determine the location of the mobile device 1700. The location component 1736 may include multiple components for determining the location and/or orientation of the mobile device 1700.

The illustrated mobile device 1700 also can include a power source 1738. The power source 1738 can include one or more batteries, power supplies, power cells, and/or other power subsystems including alternating current (“AC”) and/or direct current (“DC”) power devices. The power source 1738 also can interface with an external power system or charging equipment via a power I/O component 1740. Because the mobile device 1700 can include additional and/or alternative components, the above embodiment should be understood as being illustrative of one possible operating environment for various embodiments of the concepts and technologies described herein. The described embodiment of the mobile device 1700 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 1700 or other devices or computers described herein, such as the computer system 1400 described above with reference to FIG. 14. For purposes of the claims, the phrase “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 1700 in order to store and execute the software components presented herein. It is also contemplated that the mobile device 1700 may not include all of the components shown in FIG. 17, may include other components that are not explicitly shown in FIG. 17, or may utilize an architecture completely different than that shown in FIG. 17.

Based on the foregoing, it should be appreciated that aspects of public-private pegged blockchains for regulatory-zone restricted whitebox programmable cellular devices have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
provisioning, by a gateway comprising a processor, a device serial number for a device;
generating, by the gateway, a device private blockchain identifier of the device;
generating, by the gateway, a device public blockchain identifier of the device;
creating, by the gateway, a device private mapping between the device serial number and the device private blockchain identifier;
creating, by the gateway, a device public mapping between the device serial number and the device public blockchain identifier;
allocating, by the gateway, a device private digital currency amount to the device private blockchain identifier;
allocating, by the gateway, a device public digital currency amount to the device public blockchain identifier;
provisioning, by the gateway, a device private service transaction cost per transaction-type to the device public blockchain identifier;
provisioning, by the gateway, a device public service transaction cost per transaction-type to the device public blockchain identifier;
provisioning, by the gateway, a device private service transaction fee per transaction-type to the device private blockchain identifier;
provisioning, by the gateway, a device public service transaction fee per transaction-type to the device public blockchain identifier;
provisioning, by the gateway, a device ruleset of the device; and
registering, by the gateway, the device public blockchain identifier and the device private blockchain identifier with a network gateway.

2. The method of claim 1, wherein generating, by the gateway, the device private blockchain identifier of the device comprises generating, by the gateway, the device private blockchain identifier of the device on a private device database; and wherein generating, by the gateway, the device public blockchain identifier of the device on a public device database.

3. The method of claim 2, wherein generating, by the gateway, the device private blockchain identifier of the device on the private device database comprises generating, by the gateway, the device private blockchain identifier of the device on a private blockchain; and wherein generating, by the gateway, the device public blockchain identifier of the device on the public device database comprises generating, by the gateway, the device public blockchain identifier of the device on a public blockchain.

4. The method of claim 1, wherein the gateway is a home gateway associated with a home data governance zone; and wherein the home data governance zone is one of a plurality of data governance zones in which the device is allowed to operate.

5. The method of claim 1, wherein the gateway is a visited gateway associated with a visited data governance zone; and wherein the visited data governance zone is one of a plurality of data governance zones in which the device is allowed to operate.

6. The method of claim 1, further comprising:
provisioning an asset serial number for an asset;
generating an asset private blockchain identifier for the asset;
generating an asset public blockchain identifier for the asset;
creating an asset private mapping between the asset serial number and the asset private blockchain identifier;
creating an asset public mapping between the asset serial number and the asset public blockchain identifier;
allocating an asset private digital currency amount to the asset private blockchain identifier;
allocating an asset public digital currency amount to the asset public blockchain identifier;
provisioning an asset private service transaction cost per transaction-type to the asset private blockchain identifier;
provisioning an asset public service transaction cost per transaction-type to the asset public blockchain identifier;
provisioning an asset private service transaction fee per transaction-type to the asset private blockchain identifier;
provisioning an asset public service transaction fee per transaction-type to the asset public blockchain identifier;
provisioning an asset ruleset for the asset; and
registering the asset public blockchain identifier and the asset private blockchain identifier with the network gateway.

7. A method comprising:
receiving, by a gateway comprising a processor, a message from a device;
parsing, by the gateway, a device serial number from the message;
parsing, by the gateway, a message type from the message;
parsing, by the gateway, a payload from the message;
determining, by the gateway, whether the device serial number is valid;
in response to determining that the device serial number is valid, retrieving a device public blockchain identifier and a device private blockchain identifier;
creating, by the gateway, a public blockchain transaction payload;
sending, by the gateway, the public blockchain transaction payload to a public blockchain transaction pool associated with a public blockchain;
obtaining, by the gateway, from the public blockchain, a public blockchain transaction result;
in response to the public blockchain transaction result indicating that the public blockchain transaction payload was successfully added to the public blockchain, obtaining, by the gateway, a public blockchain transaction ID;
creating, by the gateway, a private blockchain transaction payload comprising the public blockchain transaction ID;
sending, by the gateway, the private blockchain transaction payload to a private blockchain transaction pool associated with a private blockchain; and
obtaining, by the gateway, from the private blockchain, a private blockchain transaction result, wherein the private blockchain transaction result indicates whether the private blockchain transaction payload was successfully added to the private blockchain.

8. The method of claim 7, further comprising determining if the message is associated with the device only or the device and an asset.

9. The method of claim 8, further comprising:
parsing, by the gateway, an asset serial number from the message;
further in response to determining that the device serial number is valid, determining, by the gateway, whether the asset serial number is valid; and
in response to determining that the asset serial number is valid, retrieving an asset public blockchain identifier and an asset private blockchain identifier.

10. The method of claim 9, wherein creating, by the gateway, the public blockchain transaction payload comprises:
in response to determining that the message is associated with the device only, adding a ruleset comprising a device ruleset to the public blockchain transaction payload; and
in response to determining that the message is associated with the device and the asset, adding the device private blockchain identifier and the ruleset comprising an asset ruleset to the public blockchain transaction payload.

11. The method of claim 10, wherein creating, by the gateway, the public blockchain transaction payload further comprises:
adding, to the public blockchain transaction payload, a public message field of a plurality of message fields of the payload of the message;
adding, to the public blockchain transaction payload, the message type;
adding, to the public blockchain transaction payload, a transaction cost for the message type; and
adding, to the public blockchain transaction payload, a transaction fee for the message type.

12. The method of claim 9, wherein creating, by the gateway, the private blockchain transaction payload comprises:
in response to determining that the message is associated with the device only, adding the ruleset comprising a device ruleset to the private blockchain transaction payload; and
in response to determining that the message is associated with the device and the asset, adding the device private blockchain identifier and the ruleset comprising an asset ruleset to the private blockchain transaction payload.

13. The method of claim 12, wherein creating, by the gateway, the private blockchain transaction payload further comprises:
adding, to the private blockchain transaction payload, a private message field of a plurality of message fields of the payload of the message;
adding, to the private blockchain transaction payload, the message type;
adding, to the private blockchain transaction payload, a transaction cost for the message type; and
adding, to the private blockchain transaction payload, a transaction fee for the message type.

14. The method of claim 7, further comprising verifying the public blockchain transaction payload and the private blockchain transaction payload.

15. A gateway comprising:
a processor; and
a memory comprising instructions that, when executed by the processor, cause the processor to perform operations comprising
receiving a message from a device,
parsing a device serial number from the message,
parsing a message type from the message,
parsing a payload from the message,
determining whether the device serial number is valid,
in response to determining that the device serial number is valid, retrieving a device public blockchain identifier and a device private blockchain identifier,
creating a public blockchain transaction payload,
sending the public blockchain transaction payload to a public blockchain transaction pool associated with a public blockchain,
obtaining, from the public blockchain, a public blockchain transaction result,
in response to the public blockchain transaction result indicating that the public blockchain transaction payload was successfully added to the public blockchain, obtaining a public blockchain transaction ID,
creating, by the gateway, a private blockchain transaction payload comprising the public blockchain transaction ID,
sending, by the gateway, the private blockchain transaction payload to a private blockchain transaction pool associated with a private blockchain, and
obtaining, from the private blockchain, a private blockchain transaction result, wherein the private blockchain transaction result indicates whether the private blockchain transaction payload was successfully added to the private blockchain.

16. The gateway of claim 15, wherein the operations further comprise determining if the message is associated with the device only or the device and an asset.

17. The gateway of claim 16, wherein the operations further comprise:
parsing an asset serial number from the message;
further in response to determining that the device serial number is valid, determining whether the asset serial number is valid; and
in response to determining that the asset serial number is valid, retrieving an asset public blockchain identifier and an asset private blockchain identifier.

18. The gateway of claim 17, wherein creating the public blockchain transaction payload comprises:
in response to determining that the message is associated with the device only, adding a ruleset comprising a device ruleset to the public blockchain transaction payload;
adding, to the public blockchain transaction payload, a public message field of a plurality of message fields of the payload of the message;
adding, to the public blockchain transaction payload, the message type;
adding, to the public blockchain transaction payload, a transaction cost for the message type; and
adding, to the public blockchain transaction payload, a transaction fee for the message type.

19. The gateway of claim 17, wherein creating, by the gateway, the private blockchain transaction payload comprises:
in response to determining that the message is associated with the device and the asset, adding the device private blockchain identifier and a ruleset comprising an asset ruleset to the private blockchain transaction payload;
adding, to the private blockchain transaction payload, a private message field of a plurality of message fields of the payload of the message;
adding, to the private blockchain transaction payload, the message type;
adding, to the private blockchain transaction payload, a transaction cost for the message type; and
adding, to the private blockchain transaction payload, a transaction fee for the message type.

20. The gateway of claim 15, wherein the operations further comprise verifying the public blockchain transaction payload and the private blockchain transaction payload.
